(19) United States
(12) Patent Application Publication
(10) Pub. No.: US 2020/0241549 A1
(43) Pub. Date: Jul. 30, 2020

(54) INFORMATION PROCESSING APPARATUS, MOVING APPARATUS, AND METHOD, AND PROGRAM

(71) Applicants: SONY CORPORATION, TOKYO (JP); SONY SEMICONDUCTOR SOLUTIONS CORPORATION, KANAGAWA (JP)

(72) Inventors: SHINGO TSURUMI, SAITAMA (JP); EIJI OBA, TOKYO (JP)

(21) Appl. No.: 16/753,648

(22) PCT Filed: Oct. 5, 2018
(86) PCT No.: PCT/JP2018/037346

§ 371 Date: Apr. 3, 2020

(30) Foreign Application Priority Data
Oct. 12, 2017 (JP) 2017-198823

(51) Int. Cl. G05D 1/02; G06T 7/536; G06T 7/70; G06T 7/20; H04N 5/247; G06K 9/00; B60W 40/04

(52) U.S. Cl. CPC G05D 1/0246; G06T 7/536; G06T 7/70; G06T 7/20; H04N 5/247; G05D 2201/02; G05D 1/0212; B60W 40/04; G06T 2207/30261; B60W 2420/42; G06K 9/00805

(57) ABSTRACT

A configuration for calculating a distance and a position of an object included in an image in a direction in which distance measurement by a distance sensor is impossible is achieved. There is included an object distance calculation unit that inputs an imaged image taken by a camera and calculates a distance of an object in the image, and the object distance calculation unit calculates a distance to the object by applying actual size information of the object and image information of an image object included in the imaged image. Moreover, an object position calculation unit calculates an object position using calculation information of the object distance calculation unit and the image information. An object actual size is obtained on the basis of an imaged image in a direction in which distance measurement by the distance sensor is possible.

### TECHNICAL FIELD

The present disclosure relates to an information processing apparatus, a moving apparatus, and a method, and a program. More specifically, the present disclosure relates to an information processing apparatus, a moving apparatus, and a method, as well as a program that calculate a distance and a position of an object outside a distance sensor detection area using a camera-imaged image.

### BACKGROUND ART

In recent years, autonomous moving apparatuses, for example, autonomous driving vehicles, robots, and the like, have been actively developed.

In order for such a moving apparatus to move along a predetermined route (path), it is necessary to calculate distances of various objects such as an oncoming vehicle and a wall that are obstacles to movement.

Examples of distance measuring devices for calculating an object distance include the following devices:

(a) a LiDAR (Light Detection and Ranging, Laser Imaging Detection and Ranging) that obtains ambient information using pulsed laser light;

(b) a radar that detects reflected waves of radio waves and measures a distance to a reflector; and

(c) a stereo camera that calculates a distance between objects in an imaged image by analyzing corresponding points of imaged images of two cameras.

These distance measuring devices, for example, are known.

However, these distance measuring devices are all expensive. In order to perform distance measurement in all directions of forward, backward, leftward, and rightward of an automobile, it is necessary to attach at least four distance measuring devices on the front, back, left, and right, which increases cost.

Therefore, in a case where a distance measuring device is attached to an automobile, it is often attached only to a front side (front) of the automobile.

As a specific example, for example, there is one in which a distance measuring device such as a LiDAR or a stereo camera is attached only to the front side of an automobile, and relatively low-cost cameras are attached at four positions on the front, back, left, and right of the automobile. For example, an around view imaging camera using a wide-angle lens, and the like, is used as the cameras.

There is no doubt that front sensing is important to detect obstacles on a front side that is the direction of travel of an automobile in a configuration equipped with autonomous driving or driving assistance.

In normal driving, however, traveling takes place on a road where there are overtaking, merging, or oncoming vehicles, and for safe driving, it is important to detect obstacles such as cars and walls not only on the front side but on the sides and the rear side, and to check distances to the obstacles.

Note that, for example, Patent Document 1 (Japanese Patent Application Laid-Open No. 2014-169922) discloses a technique for improving distance detection accuracy for an object by combining a millimeter wave output by a radar and an imaged image of a camera.

However, this technique described in Patent Document 1 is to use two different pieces of sensor information of radar millimeter wave detection information and imaged image.

Therefore, in order to measure a distance to an object in all directions of front, back, left, and right of an automobile, it is necessary to attach the radar and the camera in each of all directions of front, back, left, and right of the automobile, which results in a problem of high cost.

### CITATION LIST

### Patent Document

Patent Document 1: Japanese Patent Application Laid-Open No. 2014-169922

### SUMMARY OF THE INVENTION

### Problems to be Solved by the Invention

The present disclosure has been made in view of the problems described above, for example, and it is an object thereof to provide an information processing apparatus, a moving apparatus, and a method, as well as a program that can calculate a distance and a position of an object in an area other than a sensing area of a distance measuring device, without attaching a large number of expensive distance measuring devices to a moving body.

### Solutions to Problems

A first aspect of the present disclosure is in an information processing apparatus including:

an object detection unit that detects an object on the basis of an imaged image taken by a camera; and

an object distance calculation unit that calculates a distance to the object, in which

the object distance calculation unit calculates a distance to an object on the basis of actual size information of the object and an imaged image of the object.

Furthermore, a second aspect of the present disclosure is in a moving apparatus including:

a forward camera that images a forward image of the moving apparatus;

a distance sensor that measures a distance to an object in a forward direction of the moving apparatus;

a second direction camera that images a second direction image other than the forward direction of the moving apparatus;

an object distance calculation unit that inputs a second direction image imaged by the second direction camera and calculates a distance to an object in the second direction image;

a planning unit that determines a path of the moving apparatus on the basis of distance information to the object calculated by the object distance calculation unit; and

an operation control unit that performs operation control of the moving apparatus according to the path determined by the planning unit, in which

the object distance calculation unit

calculates a distance to the object on the basis of actual size information of the object and a captured image of the object included in the second direction image.

Furthermore, a third aspect of the present disclosure is in an information processing method executed in an information processing apparatus, the method having

an object distance calculation step in which an object distance calculation unit inputs an imaged image taken by a camera, and calculates a distance of an object in the image, in which

the object distance calculation step

calculates a distance to the object by applying actual size information of the object and image information of an image object included in the imaged image.

Furthermore, a fourth aspect of the present disclosure is in a moving apparatus control method executed in a moving apparatus, in which

the moving apparatus includes:

a forward camera that images a forward image of the moving apparatus;

a distance sensor that measures a distance to an object in a forward direction of the moving apparatus; and

a second direction camera that images a second direction image other than the forward direction of the moving apparatus,

the moving apparatus control method includes:

an object distance calculation step in which an object distance calculation unit inputs an imaged image taken by the camera and calculates a distance of an object in the image;

a planning step in which a planning unit inputs object distance information calculated by the object distance calculation unit and determines a path of the moving apparatus; and

an operation control step in which an operation control unit performs operation control of the moving apparatus according to the path determined by the planning unit, and

the object distance calculating step

is a step of calculating a distance to the object by applying actual size information of the object and image information of an image object included in the second direction image.

Furthermore, a fifth aspect of the present disclosure is in a program that executes information processing in an information processing apparatus, having

an object distance calculation step in which an object distance calculation unit inputs an imaged image taken by a camera and calculates a distance of an object in the image, in which

the program causes the object distance calculating step to

calculate a distance to the object by applying actual size information of the object and image information of an image object included in the imaged image.

Furthermore, a sixth aspect of the present disclosure is in a program that executes a moving apparatus control process in a moving apparatus, in which

the moving apparatus includes:

a forward camera that images a forward image of the moving apparatus;

a distance sensor that measures a distance to an object in a forward direction of the moving apparatus; and

a second direction camera that images a second direction image other than the forward direction of the moving apparatus,

the program executes:

an object distance calculation step in which an object distance calculation unit inputs an imaged image taken by the camera and calculates a distance of an object in the image;

a planning step in which a planning unit inputs object distance information calculated by the object distance calculation unit and determines a path of the moving apparatus; and

an operation control step in which an operation control unit performs operation control of the moving apparatus according to the path determined by the planning unit, and

in the object distance calculating step,

a distance to the object is calculated by applying actual size information of the object and image information of an image object included in the second direction image.

Note that a program of the present disclosure is a program that can be provided by, for example, a storage medium or a communication medium provided in a computer-readable format to an information processing apparatus or a computer system that can execute various program codes. By providing such a program in a computer-readable format, processing corresponding to the program is implemented on the information processing apparatus or the computer system.

Other objects, features, and advantages of the present disclosure will become apparent from a more detailed description based on embodiments of the present disclosure described below and the accompanying drawings. Note that a system in the present description is a logical set configuration of a plurality of devices, and is not limited to one in which devices with respective configurations are in the same enclosure.

### Effects of the Invention

With a configuration of an embodiment of the present disclosure, a configuration for calculating a distance and a position of an object included in an image in a direction in which distance measurement by a distance sensor is impossible is achieved.

Specifically, for example, there is included an object distance calculation unit that inputs an imaged image taken by a camera and calculates a distance of an object in the image, and the object distance calculation unit calculates a distance to the object by applying actual size information of the object and image information of an image object included in the imaged image. Moreover, an object position calculation unit calculates an object position using calculation information of the object distance calculation unit and the image information. An object actual size is obtained on the basis of an imaged image in a direction in which distance measurement by the distance sensor is possible.

With this configuration, a configuration for calculating a distance and a position of an object included in an image in a direction in which distance measurement by a distance sensor is impossible is achieved.

Note that effects described in the present description are merely examples and are not limited, and additional effects may be provided.

### BRIEF DESCRIPTION OF DRAWINGS

FIG. 1 is a diagram illustrating a configuration example of a moving apparatus.

FIG. 2 is a diagram describing a setting example of a distance measurable area of a distance sensor mounted in the moving apparatus and the image imaging area of a camera.

FIG. 3 is a diagram describing a setting example of the distance measurable area of the distance sensor mounted in the moving apparatus and the image imaging area of the camera.

FIG. 4 is a diagram illustrating a configuration example of an information processing apparatus mounted in the moving apparatus.

FIG. 5 is a diagram illustrating an example of data stored in an object information storage unit.

FIG. 6 is a diagram illustrating a process using an imaged image of a forward camera and measurement information of the distance sensor.

FIG. 7 is a diagram illustrating an actual size calculation process of an object using an imaged image of the forward camera and the measurement information of the distance sensor.

FIG. 8 is a diagram describing processing using an imaged image of a camera other than the forward camera and stored information in the storage unit.

FIG. 9 is a diagram describing a calculation process of a distance and a position to an object using an imaged image of the camera other than the forward camera and the stored information in the storage unit.

FIG. 10 is a diagram illustrating a flowchart describing a sequence of processes executed by the information processing apparatus.

FIG. 11 is a flowchart illustrating a flowchart describing the sequence of processes executed by the information processing apparatus.

FIG. 12 is a diagram illustrating a configuration example of a vehicle control system of the moving apparatus.

FIG. 13 is a diagram illustrating a hardware configuration example of the information processing apparatus.

### MODE FOR CARRYING OUT THE INVENTION

Hereinafter, details of an information processing apparatus, a moving apparatus, and a method, and a program of the present disclosure will be described with reference to the drawings. Note that the description will be made according to the following items.

1. Configuration example of moving apparatus of present disclosure

2. Configurations and processes of moving apparatus and information processing apparatus of present disclosure

3. Details of calculation process of distance, size, and position of object

3-1. Example of distance, position, and size calculation process for object in imaged image of forward camera

3-2. Example of distance and position calculation process for object included in camera-imaged image other than forward direction

4. Sequence of processes executed by information processing apparatus

5. Configuration example of moving apparatus

6. Configuration example of information processing apparatus

7. Summary of configurations of present disclosure

[1. Configuration Example of Moving Apparatus of Present Disclosure]

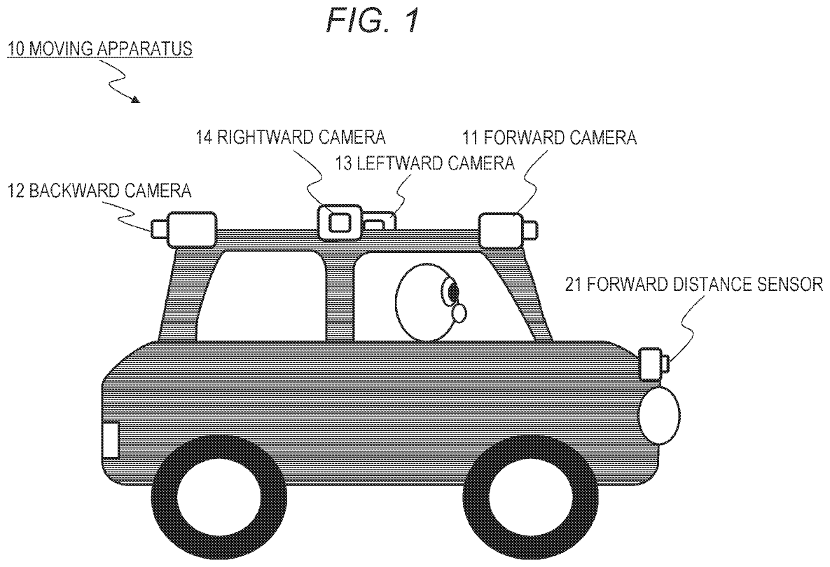

First, a configuration example of a moving apparatus of the present disclosure will be described with reference to FIG. 1.

FIG. 1 illustrates an example of a moving apparatus 10 of the present disclosure.

Note that in the following embodiment, an example in which the moving apparatus 10 is an automobile (vehicle) will be described as an example of the moving apparatus 10. However, configurations and processes of the present disclosure can be used in various moving apparatuses other than automobiles.

For example, the present disclosure can be applied to various moving apparatuses such as robots (walking type or traveling type), flying objects such as drones, or apparatuses that move on or under water such as ships and submarines.

As illustrated in FIG. 1, a plurality of cameras and one distance sensor are mounted in the moving apparatus 10.

The mounted cameras are the following cameras.

The four cameras are:

a forward camera 11 that images a forward direction of the moving apparatus 10;

a backward camera 12 that images a backward direction of the moving apparatus 10;

a leftward camera 13 that images a leftward direction of the moving apparatus 10; and

a rightward camera 14 that images a rightward direction of the moving apparatus 10.

Note that as these cameras 11 to 14, a camera that performs normal image imaging or a camera (monocular camera) provided with a wide-angle lens such as a fish-eye lens can be used.

Further, the distance sensor mounted in the moving apparatus 10 is the following one distance sensor.

The one distance sensor is:

a forward distance sensor 21 that measures a distance to an object in a forward direction of the moving apparatus 10.

Note that the distance sensor 21 includes, for example, any one of the following devices as listed below:

(a) a LiDAR (Light Detection and Ranging, Laser Imaging Detection and Ranging) that obtains ambient information using pulsed laser light;

(b) a radar that detects reflected waves of radio waves and measures a distance to a reflector; and

(c) a stereo camera that calculates a distance between objects in an imaged image by analyzing corresponding points of imaged images of two cameras.

Note that the distance sensor 21 is not limited to one of the above-described devices, and any other distance measuring device can be used.

As described above, one forward distance sensor 21 that can measure a distance to an object in the forward direction and the four cameras 11 to 14 that can image images in all directions of front, back, left, and right are mounted in the moving apparatus 10.

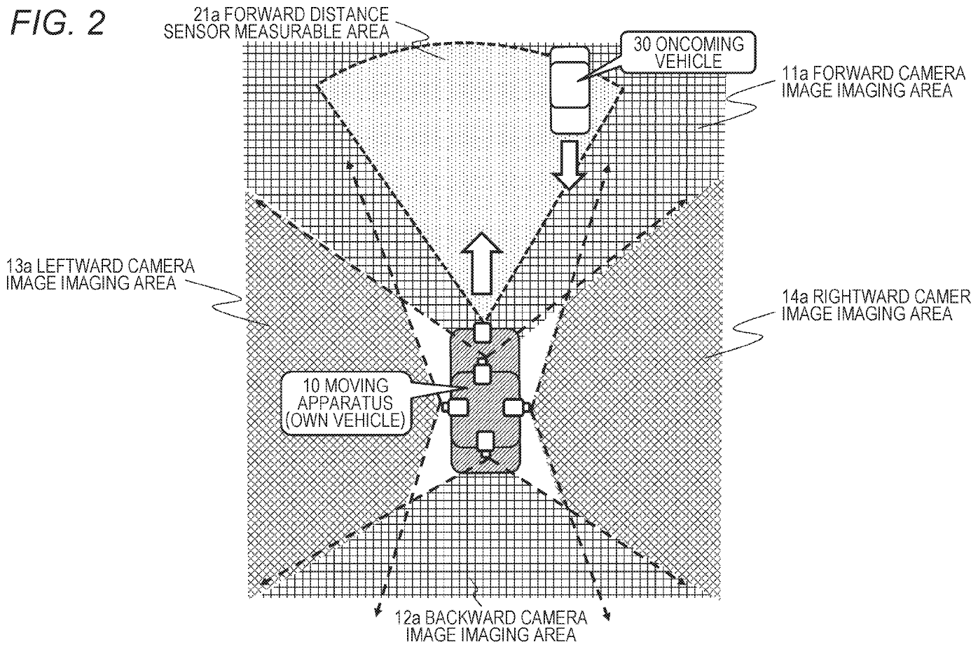

Next, a distance measurable area by the forward distance sensor 21 and image imaging areas by the four cameras 11 to 14 will be described with reference to FIG. 2.

FIG. 2 illustrates the moving apparatus 10 at the center. The moving apparatus 10 is the moving apparatus 10 described with reference to FIG. 1, in which one forward distance sensor 21 and four cameras 11 to 14 that can image images in all directions of front, back, left, and right are mounted.

An upward direction in the drawing is the front, and the moving apparatus 10 is moving (running) in the forward direction. 29

There is an oncoming vehicle 30 on the right front side of the moving apparatus 10, and the oncoming vehicle 30 travels downward in the diagram.

The oncoming vehicle 30 is set to approach in a direction of the moving apparatus 10 over time, and to pass by the right side of the moving apparatus 10.

FIG. 2 illustrates the following areas:

a forward camera image imaging area 11a;

a backward camera image imaging area 12a;

a leftward camera image imaging area 13a;

a rightward camera image imaging area 14a; and

a forward distance sensor measurable area 21a.

As can be seen from the diagram, the image imaging areas by the four cameras 11 to 14 cover all peripheral areas of the moving apparatus 10.

However, the forward distance sensor measurable area 21a, which is an object distance measurable area by the forward distance sensor 21, is only a front area of the moving apparatus 10.

In setting of FIG. 2, the oncoming vehicle 30 is in an overlapping area of the forward camera image imaging area 11a and the forward distance sensor measurable area 21a.

Therefore, the moving apparatus 10 can recognize the oncoming vehicle 30 from an imaged image of the forward camera 11, and can also obtain a distance of the oncoming vehicle 30 measured by the forward distance sensor 21.

For example, an action planning unit in an autonomous driving apparatus or a driving support apparatus provided in the moving apparatus 10 inputs imaged image information of the forward camera 11 and distance information of the oncoming vehicle 30 measured by the forward distance sensor 21, and can perform path setting on the basis of the input information so as to avoid a collision with the oncoming vehicle 30.

However, with passage of time, the oncoming vehicle 30 approaches in the direction of the moving apparatus 10 and passes by the right side of the moving apparatus 10. In this process, the oncoming vehicle 30 moves to outside of the forward distance sensor measurable area 21a.

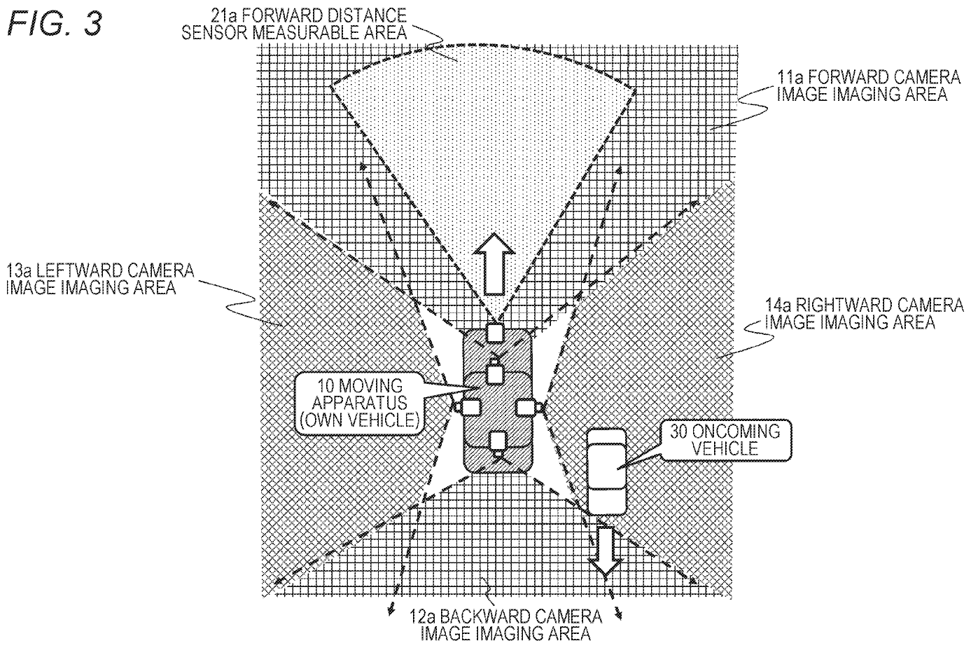

The position of the oncoming vehicle 30 after a predetermined time has elapsed will be described with reference to FIG. 3.

After a predetermined time has elapsed from the setting illustrated in FIG. 2, the oncoming vehicle 30 passes on the right side of the moving apparatus 10 as illustrated in FIG. 3.

In the state illustrated in FIG. 3, the oncoming vehicle 30 is inside the rightward camera image imaging area 14a but outside the forward distance sensor measurable area 21a.

Therefore, the moving apparatus 10 can only recognize the oncoming vehicle 30 from an imaged image of the rightward camera 14, and cannot obtain the distance of the oncoming vehicle 30 by the distance sensor.

The moving apparatus 10 of the present disclosure or the information processing apparatus mounted inside the moving apparatus 10 are capable of calculating a distance of an object, that is, a distance to an object such as the oncoming vehicle 30 illustrated in FIG. 3, even if distance detection information by the distance sensor cannot be obtained.

Hereinafter, configurations of the present disclosure will be described.

[2. Configurations and Processes of Moving Apparatus and Information Processing Apparatus of Present Disclosure]

Next, configurations and processes of the moving apparatus and the information processing apparatus of the present disclosure will be described.

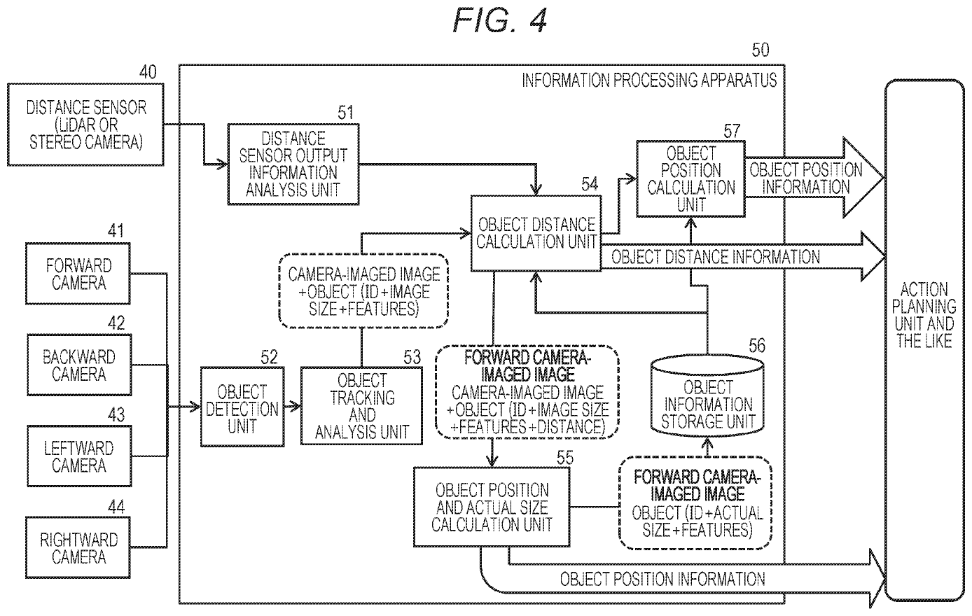

FIG. 4 is a block diagram illustrating a configuration example of the information processing apparatus mounted in the moving apparatus 10 of the present disclosure.

As illustrated in FIG. 4, an information processing apparatus 50 inputs output information of a distance sensor 40 as sensor detected information and camera-imaged images of a forward camera 41, a backward camera 42, a leftward camera 43, and a rightward camera 44, and calculates object distances and positions of objects in all directions on the basis of the input information.

These sensors, the distance sensor 40, the forward camera 41, the backward camera 42, the leftward camera 43, and the rightward camera 44, correspond to the distance sensor and the cameras mounted in the moving apparatus 10 described with reference to FIGS. 1 to 3.

As described with reference to FIGS. 2 and 3, the distance sensor 40 is a sensor whose distance measurable area is only in the forward direction of the moving apparatus 10.

As described with reference to FIGS. 2 and 3, the forward camera 41, the backward camera 42, the leftward camera 43, and the rightward camera 44 can image images in all directions of front, back, left, and right of the moving apparatus 10.

As illustrated in FIG. 4, the information processing apparatus 50 has a distance sensor output information analysis unit 51, an object detection unit 52, an object tracking and analysis unit 53, an object distance calculation unit 54, an object position and actual size calculation unit 55, an object information storage unit 56, and an object position calculation unit 57.

The distance sensor output information analysis unit 51 inputs sensor information output from the distance sensor 40, and analyzes all distances in areas of detectable ranges by the sensors on the basis of the sensor information. For example, a depth map indicating distance information of all distances in the areas of the detectable range is generated.

However, as described with reference to FIGS. 2 and 3, the distance sensor 40 is a sensor whose distance measurable area is only in the forward direction of the moving apparatus 10, and the distance sensor output information analysis unit 51 analyzes only a distance in the front area of the moving apparatus 10.

The object detection unit 52 inputs camera-imaged images of these cameras, the forward camera 41, the backward camera 42, the leftward camera 43, and the rightward camera 44, and detects an object from each image.

The object is, for example, an object such as an oncoming vehicle described with reference to FIGS. 2 and 3.

Note that the object includes all objects that can be an obstacle to movement of the moving apparatus 10, such as a pedestrian, a card rail, and a side wall, in addition to a vehicle such as an oncoming vehicle or a preceding vehicle.

The object tracking and analysis unit 53 executes a tracking process of an object detected by the object detection unit 52. That is, an identifier (ID) is set to each of objects detected from the images, and each object is tracked according to movement on the image.

Moreover, the object tracking and analysis unit 53 obtains a size (for example, the number of vertical (h)×horizontal (w) pixels) on an image of the object to which the object ID is set and feature information of the object.

The feature information of the object is, for example, features such as a color, a shape, and a pattern of the object.

The object tracking and analysis unit 53

outputs correspondence data of the object ID, the object image size, and the object feature information to the object distance calculation unit 54 together with the camera-imaged image.

The object distance calculation unit 54 inputs the following pieces of information from the distance sensor output information analysis unit 51 and the object tracking and analysis unit 53, respectively. The pieces of information are:

(a) distance information of a distance measurable area ahead of the moving apparatus 10, from the distance sensor output information analysis unit 51; and

(b) correspondence data of a camera-imaged image, the object ID of an object included in the image, an object image size, and object feature information, from the object tracking and analysis unit 53.

The object distance calculation unit 54 inputs these pieces of information and calculates the distance of the object included in the image, that is, the object distance.

However, a process of calculating the distance to an object executed by the object distance calculation unit 54 is different in the following two cases:

(1) a case where the camera-imaged image input from the object tracking and analysis unit 53 is an imaged image of the forward camera 41; and

(2) a case where the camera-imaged image input from the object tracking and analysis unit 53 is an imaged image of a camera other than the forward camera 41, that is, an imaged image of the backward camera 42, the leftward camera 43, or the rightward camera 44,

In the case (1) described above, that is, the case where the camera-imaged image input from the object tracking and analysis unit 53 is an imaged image of the forward camera 41, an object included in the camera-imaged image is included in the distance measurable area of the distance sensor 40, and the distance to the object can be immediately calculated using measurement information of the distance sensor.

On the other hand, in the case (2) described above, that is, the case where the camera-imaged image input from the object tracking and analysis unit 53 is an imaged image of the backward camera 42, the leftward camera 43, or the rightward camera 44 other than the forward camera 41, the object included in the camera-imaged image is outside the distance measurable area of the distance sensor 40, and the distance to the object cannot be calculated using measurement information of the distance sensor.

In this case, the object distance calculation unit 54 calculates the distance to the object using input information from the object tracking and analysis unit 53, that is, the camera-imaged image and stored information in the object information storage unit 56.

Details of this process will be described later.

Prior to detailed description of an object distance calculation process executed by the object distance calculation unit 54, first, a flow of a series of processes in each component unit of the information processing apparatus 50 in FIG. 4 will be described.

Having calculated the distance to an object of an object detected from the image, the object distance calculation unit 54 outputs the calculated distance to the object to a module that uses the distance to the object, such as an action planning unit that sets a movement path (path) of the moving apparatus for example.

An action planning unit provided in the moving apparatus 10 refers to the distance to the object calculated by the object distance calculation unit 54, and sets the movement path so as not to contact an object such as an oncoming vehicle and performs traveling.

Note that the object distance calculation unit 54 executes the following process only in a case where the image on which the object distance calculation process is performed is an imaged image of the forward camera 41.

The object distance calculation unit 54 outputs object distance information of an object included in the imaged image of the forward camera 41, and input information from the object tracking and analysis unit 53, that is, data of

a camera-imaged image (imaged image of the forward camera 41), and

correspondence data of the object ID and the object image size,

to the object position and actual size calculation unit 55.

The object position and actual size calculation unit 55 uses information input from the object distance calculation unit 54, that is, data of

a camera-imaged image (imaged image of the forward camera 41) ,

correspondence data of the object ID and the object image size, and

object distance information,

so as to calculate an actual size that is the actual size of the object and a position of the object.

Details of the calculation process of the object actual size and the position will be described later.

The object position and actual size calculation unit 55 calculates the actual size and the position of the object included in the imaged image of the forward camera 41, and outputs the calculated object position to a module using object information such as the action planning unit.

Moreover, the object position and actual size calculation unit 55 stores the calculated object actual size in the object information storage unit 56 in association with the object ID and the object feature information.

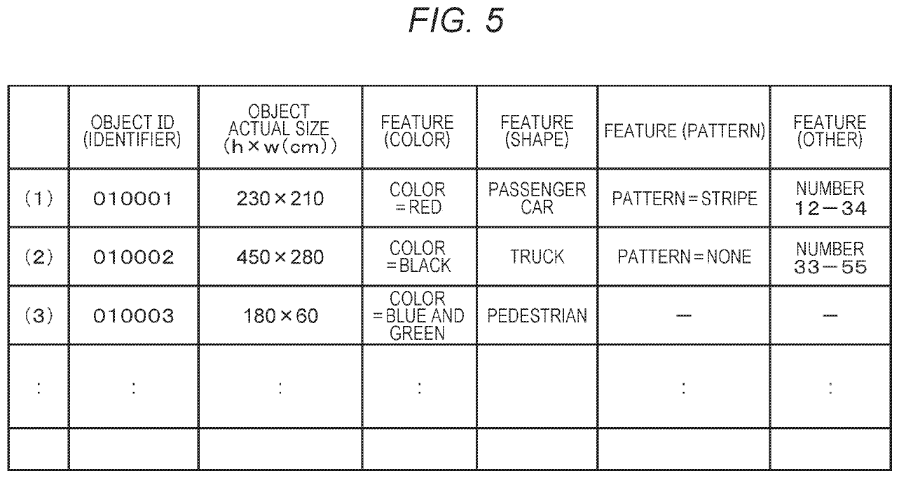

An example of data stored in the object information storage unit 56 is illustrated in FIG. 5.

As illustrated in FIG. 5, in the object information storage unit 56, respective pieces of information of

object ID,

object actual size, and

object feature information (color, shape, pattern, and the like),

are recorded as corresponding data for each object unit.

Note that all of these are objects whose distances are measured by the distance sensor 40, and are objects included in an image imaged by the forward camera 41 in the present embodiment.

The object position calculation unit 57 calculates a position of an object in an imaged image of a camera other than the forward camera 41, that is, the backward camera 42, the leftward camera 43, or the rightward camera 44.

Details of this process will be described later.

Object position information calculated by the object position calculation unit 57 is output to a module using object information such as the action planning unit, and is used for path setting or the like of the moving apparatus.

58

[3. Details of Calculation Process of Distance, Size, and Position of Object]

Next, details of processes executed in the object distance calculation unit 54, the object position and actual size calculation unit 55, and the object position calculation unit 57 of the information processing apparatus 50 illustrated in FIG. 4 will be described.

First, as described above, the object distance calculation process executed in the object distance calculation unit 54 is different in the following two cases:

(1) a case where the camera-imaged image input from the object tracking and analysis unit 53 is an imaged image of the forward camera 41; and

(2) a case where the camera-imaged image input from the object tracking and analysis unit 53 is an imaged image of the backward camera 42, the leftward camera 43, or the rightward camera 44 other than the forward camera 41,

In the case (1) described above, that is, a case where the camera-imaged image input from the object tracking and analysis unit 53 is an imaged image of the forward camera 41, an object included in the camera-imaged image is included in the distance measurable area of the distance sensor 40, and the distance to the object can be immediately calculated using measurement information of the distance sensor.

On the other hand, in the case (2) described above, that is, a case where the camera-imaged image input from the object tracking and analysis unit 53 is an imaged image of the backward camera 42, the leftward camera 43, or the rightward camera 44 other than the forward camera 41, the object included in the camera-imaged image is outside the distance measurable area of the distance sensor 40, and the distance to the object cannot be calculated using measurement information of the distance sensor.

In this case, the object distance calculation unit 54 calculates the distance to the object using input information from the object tracking and analysis unit 53, that is, the camera-imaged image and stored information in the object information storage unit 56.

Moreover, the object position and actual size calculation unit 55 calculates the position and the size of the object included in the imaged image of the forward camera 41.

Further, the object position calculation unit 57 calculates the position of an object included in one of imaged images of the backward camera 42, the leftward camera 43, or the rightward camera 44, which is a camera other than the forward camera 41.

Hereinafter, examples of process will be described in the following two cases:

(1) a case where the camera-imaged image input from the object tracking and analysis unit 53 is an imaged image of the forward camera 41; and

(2) a case where the camera-imaged image input from the object tracking and analysis unit 53 is an imaged image of the backward camera 42, the leftward camera 43, or the rightward camera 44 other than the forward camera 41.

Specific examples of processing in these two cases will be sequentially described.

[3-1. Example of Distance, Position, and Size Calculation Process for Object in Imaged Image of Forward Camera]

First, an example of the distance, position, and size calculation process for an object in an imaged image of the forward camera 41 will be described.

Note that the example of process described below is an example of process in a case where the distance of an object in a camera-imaged image can be calculated using measurement information of the distance sensor as it is.

In the present embodiment, the distance sensor 40 is attached to a front of the moving apparatus 10, and the distance of an object in an imaged image of the forward camera 41 can be calculated using measurement information of the distance sensor 40 as it is.

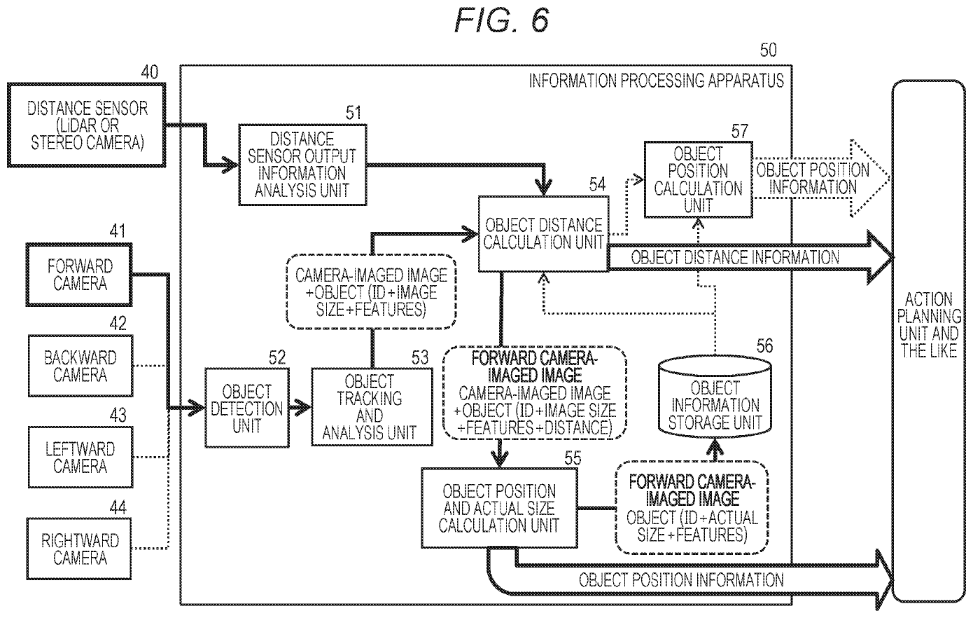

FIG. 6 is a diagram illustrating an example of process in a case where the information processing apparatus 50 inputs an imaged image of the forward camera 41 and calculates the distance of an object included in the imaged image of the forward camera 41.

In FIG. 6, a flow of data that occurs when an imaged image of the forward camera 41 is input is indicated by a thick arrow.

As illustrated in FIG. 6, when inputting an imaged image of the forward camera 41, the information processing apparatus 50 can input sensor output from the distance sensor 40 for an area overlapping with an imaged area of the imaged image of the forward camera 41, that is, distance information.

The distance sensor output information analysis unit 51 inputs sensor information that is output from the distance sensor 40, and generates a detection range by the sensor, that is, distance information of the front area of the moving apparatus 10 on the basis of the sensor information.

The object detection unit 52 inputs a camera-imaged image of the forward camera 41 and detects an object from the forward image.

The object includes all objects that can be an obstacle to movement of the moving apparatus 10, such as a vehicle, a pedestrian, or a card rail.

The object tracking and analysis unit 53 executes a tracking process of an object detected by the object detection unit 52, sets an object ID for each object, and moreover obtains an object image size (for example, the number of vertical (h)×horizontal (w) pixels) and feature information (color, shape, pattern, and the like) of the object.

The object tracking and analysis unit 53

outputs correspondence data of the object ID, the object image size, and the object feature information to the object distance calculation unit 54 together with the camera-imaged image.

The object distance calculation unit 54 inputs the following pieces of information from the distance sensor output information analysis unit 51 and the object tracking and analysis unit 53, respectively. The pieces of information are:

(a) distance information of a distance measurable area ahead of the moving apparatus 10 from the distance sensor output information analysis unit 51;

(b) correspondence data of a forward camera-imaged image, the object ID of an object included in the image, an object image size, and object feature information from the object tracking and analysis unit 53.

The object distance calculation unit 54 inputs these pieces of information and calculates the distance of the object included in the image, that is, the distance to the object.

In the example illustrated in FIG. 6, the camera-imaged image input from the object tracking and analysis unit 53 is an imaged image of the forward camera 41, and the object included in the forward camera-imaged image is in the distance measurable area of the distance sensor 40.

Therefore, the object distance calculation unit 54 can immediately calculate the distance to the object using sensor information of the distance sensor 40, that is, output information of the distance sensor output information analysis unit 51.

Having calculated the distance to the object of the detected object from the imaged image of the forward camera 41, the object distance calculation unit 54 outputs the calculated distance to the object to a module that uses the object distance, such as the action planning unit that sets a movement path (path) of the moving apparatus for example.

The action planning unit provided in the moving apparatus 10 refers to the distance to the object calculated by the object distance calculation unit 54, and sets the movement path so as not to contact an object such as an oncoming vehicle and performs traveling.

Moreover, the object distance calculation unit 54 outputs object distance information of the object included in the imaged image of the forward camera 41, and input information from the object tracking and analysis unit 53, that is, data of

a camera-imaged image (imaged image of the forward camera 41), and

correspondence data of an object ID and an object image size,

to the object position and actual size calculation unit 55.

The object position and actual size calculation unit 55 uses information input from the object distance calculation unit 54, that is, data of

a camera-imaged image (imaged image of the forward camera 41) ,

correspondence data of the object ID and the object image size, and

object distance information,

so as to calculate an actual size that is the actual size of the object and a position of the object.

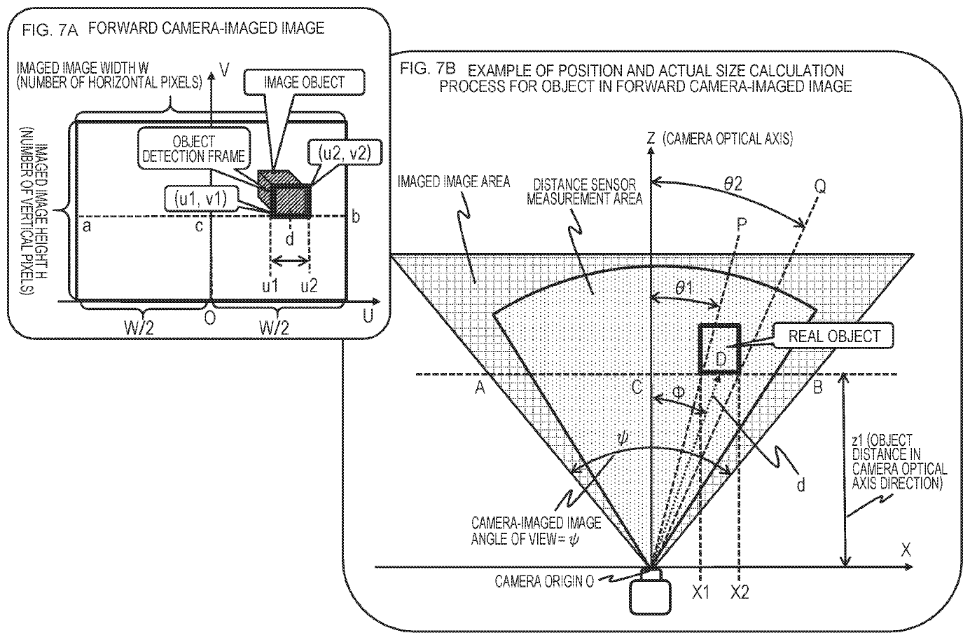

Details of the calculation process of the object actual size and the position will be described with reference to FIG. 7.

FIG. 7 illustrates the following diagrams.

(1) A forward camera-imaged image

(2) Example of position and actual size calculation process of object in forward camera-imaged image

In the forward camera-imaged image in FIG. 7(1), a horizontal axis corresponding to horizontal pixels of the image is a U axis, and a vertical axis corresponding to vertical pixels of the image is a V axis. An imaged image is an image in which:

the number of vertical pixels=H; and

the number of horizontal pixels=W.

An origin O is set at a lower end of the vertical pixels and a midpoint position of the number of horizontal pixels W.

An object (image object) is imaged in this image.

This image object corresponds to, for example, the oncoming vehicle 30 illustrated in FIG. 2.

An object detection frame is illustrated on a front face of the image object.

The object detection frame has:

coordinates (u1, v1) at a lower left corner of the object detection frame; and

coordinates (u2, v2) at an upper right corner of the object detection frame.

The coordinates (u1, v1) and (u2, v2) indicating an object area are coordinate information that can be obtained from the camera-imaged image.

An XZ coordinate space illustrated in the example of the position and actual size calculation process of the object in the forward camera-imaged image illustrated in FIG. 7(2) corresponds to a real space.

With a camera position of the forward camera being the origin (camera origin O), an axis (left-right axis) perpendicular to the camera imaging direction (forward direction) is a horizontal axis X axis, and a Z axis illustrated as a vertical axis in the diagram corresponds to a camera optical axis (camera imaging direction). A value on the Z-axis corresponds to a distance (depth) in a vertical direction from the camera.

A real object illustrated in FIG. 7(2) is an object imaged in the image in FIG. 7(1).

The real object is in the forward camera image imaging area and in a distance sensor measurement area.

A front face (camera side) of a real object position is at a position of z1 in the Z-axis (camera optical axis) direction from the camera origin, and has an X coordinate in the range of X1, X2.

A distance from the camera origin O to the object (center D of the front face X1 to X2), that is, an object distance OD is:

object distance OD=d.

The object distance d is a value calculated from sensor information of the distance sensor 40.

Moreover,

an angle of view of camera-imaged image=Ψ

is a known value.

An image on a segment ab parallel to the U axis passing through the object on the image in FIG. 7(1) corresponds to an image of a segment AB passing through the front face of the object in the real space in FIG. 7(2) (the segment AB parallel to the X axis on Z=z1).

That is, an image obtained by reducing an actual size of the line AB in the real space corresponds to an image of the line ab in an image space.

Therefore, the position of the image object on the segment ab of the forward camera-imaged image in FIG. 7(1) and the position of the real object on the segment AB of the real space in FIG. 7(2) are in a same positional relationship.

Under these conditions, the position and size of the real object in the real space are calculated.

Specifically, the X coordinates X1, X2 of the real object illustrated in FIG. 7(2) are calculated as an object position.

Moreover, a horizontal length, that is, a width, which is a size of the real object, can be calculated from the X coordinates X1, X2 of the real object by X2−X1.

Note that if the width of the real object can be obtained, other sizes such as a height of the real object can be obtained. That is, for example, the ratio of a width and a height of the image object is the same as the ratio of a width and a height of the real object, and a length of each side of the real object can be calculated by calculating a ratio of each side from the image object and performing conversion corresponding to an actual size of the real object.

A calculation process of the X coordinates X1, X2 indicating the position of the real object illustrated in FIG. 7(2) and a calculation process of the size are performed by sequentially executing the following processes A1 to A5.

(Process A1) An angle Φ formed by a straight line OD (a straight line indicated as the object distance d in the diagram) connecting the camera origin O to the object front-face center D and the Z axis (camera optical axis) in the real space is calculated.

(Process A2) A separation distance from the camera origin O in the Z-axis (camera optical axis) direction in the real space, that is, a Z coordinate z1 of the real object is calculated.

(Process A3) An angle θ1 formed by a segment OP connecting the camera origin O and a left end (X coordinate=X1) of the front (camera side) of the real object and the Z axis in the real space, and an angle θ2 formed by a segment OQ connecting the camera origin O and a right end (X coordinate=X2) of the front (camera side) of the real object and the Z axis, are calculated.

(Process A4) An object position X1, X2 is calculated using the values calculated in the processes A1 to A3.

(Process A5) Calculation process of size of real object

Hereinafter, details of each of the above-described (Process A1) to (Process A5) will be described.

(Process A1)

First, a process A1, that is, a calculation process of an angle Φ formed by a straight line OD (a straight line indicated as the object distance d in the diagram) connecting the camera origin O to the object front-face center D and the Z axis (camera optical axis) in the real space will be described.

A center point of the segment ab in the image in FIG. 7(1) is c, and a center point of the image object in the segment ab is d.

On the other hand, a center point of the segment AB in the real space in FIG. 7(2) is C, and a center point of the real object in the segment AB is D.

Further, U coordinates of left and right end points of the image object in the segment ab in the image in FIG. 7(1) are u1, u2.

At this time, a ratio of cb and cd and a ratio of CB and CD are the same, and

cb:cd=CB:CD (Equation 1),

above-described (Equation 1) holds.

From above-described (Equation 1), following (Equation 2) is obtained.

W/2:(u1+u2)/2=tan(ψ/2):tan Φ (Equation 2)

In above-described (Equation 2),

W represents the number of horizontal pixels of the forward camera-imaged image,

u1, u2 represent coordinate information of the image object of the forward camera-imaged image, and

ψ represents an angle of view of the forward camera,

all of which are known values.

Therefore, from above-described (Equation 2), the angle Φ, that is, the angle Φ formed by the straight line OD (the straight line indicated as the object distance d in the diagram) connecting the camera origin O to the object front-face center D and the Z axis (camera optical axis) can be calculated.

(Process A2)

Next, a process A2, that is, a process of calculating a separation distance from the camera origin O in the Z-axis (camera optical axis) direction in the real space, that is, a Z coordinate=z1 of the real object will be described.

In the real space illustrated in FIG. 7(2), a relationship among

the distance d from the camera origin O of the real object,

the separation distance of the real object from the camera origin O in the Z axis (camera optical axis) direction, that is, the Z coordinate=z1 of the real object, and

the angle=Φ formed by the segment OD connecting the camera origin O and the real object center point D and the Z axis is represented as follows.

cos Φ=z1/d (Equation 3)

From this (Equation 3),

z1=cos Φ×d (Equation 4)

is obtained.

In above-described (Equation 4),

d represents the object distance d, which is a known value from a measurement value of the distance sensor 40.

Φ represents a known value calculated according to (Equation 2).

Therefore, from above-described (Equation 4),

the separation distance of the real object from the camera origin O in the Z-axis (camera optical axis) direction, that is, the Z coordinate=z1 of the real object can be calculated.

(Process A3)

Next, a process A3, that is, a calculation process of an angle θ1 formed by a segment OP connecting the camera origin O and a left end (X coordinate=X1) of the front (camera side) of the real object and the Z axis in the real space, and an angle θ2 formed by a segment OQ connecting the camera origin O and a right end (X coordinate=X2) of the front (camera side) of the real object and the Z axis, will be described.

As described above, an image on the segment ab parallel to the U axis passing through the object on the image in FIG. 7(1) corresponds to an image on the segment AB passing through the front face of the object in the real space in FIG. 7(2) (the segment AB parallel to the X axis on Z=z1).

That is, an image obtained by reducing an actual size of the line AB in the real space corresponds to an image of the line ab in an image space.

Therefore, the u-coordinates u1, u2 of the end points of the image object position in the segment ab of the forward camera-imaged image in FIG. 7(1) and the X coordinates X1, X2 of the end points of the real object position in the segment AB of the real space in FIG. 7(2) are in the same positional relationship.

From this relationship,

as correspondences among the values of:

a length cb from c to b,

a length cu1 from c to u1,

a length cu2 from c to u2

in the image in FIG. 7(1); and

a length CB from C to B,

a length CX1 from C to X1,

a length CX2 from C to X2

in the real space in FIG. 7(2)

following (Equation 5) and (Equation 6) hold.

cb:cu1=CB:CX1 (Equation 5)

cb:cu2=CB:CX2 (Equation 6)

Above-described (Equation 5) and (Equation 6) hold.

From (Equation 5) and (Equation 6) described above,

W/2:cu1=tan(ψ/2):tan(θ1) (Equation 7)

W/2:cu2=tan(ψ/2):tan(θ2) (Equation 8)

are obtained.

In above-described (Equation 7), an unknown is only θ1, and thus θ1 can be calculated from (Equation 7).

Further, in above-described (Equation 8), an unknown is only θ2, and thus θ2 can be calculated from (Equation 8).

(Process A4)

Next, a process A4, that is, a process of calculating the object position X1, X2 using the values calculated in the processes A1 to A3 will be described.

A relationship among the X coordinate=X1 of the left end of the front (camera side) of the real object illustrated in FIG. 7(2),

the Z coordinate=z1 of the real object, and

the angle=θ1 formed by the segment OP and the Z axis

can be expressed by following (Equation 9).

X1=z1×sin θ1 (Equation 9)

Similarly, a relationship among the X coordinate=X2 of the right end of the front (camera side) of the real object,

the Z coordinate=z1 of the real object,

the angle=θ2 formed by the segment OQ and the Z axis,

can be expressed by following (Equation 10).

X2=z1×sin θ2 (Equation 10)

In above-described (Equation 9) and (Equation 10), z1 is calculated according to (Equation 4) and is known.

Further, θ1, θ2 are calculated according to (Equation 7) and (Equation 8) and are known.

Therefore, from (Equation 9) and (Equation 10) described above,

it is possible to calculate the X coordinates=X1, X2 of the left and right ends of the front (camera side) of the real object.

The object position information X1, X2 is output to and used by a module using object position information such as the action planning unit.

(Process A5) Calculation process of size of real object

Next, a process A5, that is, a process of calculating the size of the real object will be described.

The size (width) of the real object in the real space in FIG. 7(2) can be calculated by following (Equation 11).

Real object size=X2−X1 (Equation 11)

The values of X1, X2 have been calculated by (Equation 9) and (Equation 10) described above, and the size (width) of the real object can be calculated according to (Equation 11) described above.

Note that the ratio of a width (u2−u1) to a height (v2−v1) of the image object illustrated in FIG. 7(1) is the same as the ratio of the width and the height of the real object illustrated in FIG. 7(2).

Therefore, if the size (width) of the real object can be obtained, the height of the real object can also be calculated according to (Equation 12) below.

Height of real object=(X2−X1)×((v2−v1)/(u2−u1)) (Equation 12)

According to the above-described processes, that is, the calculation processes described with reference to FIG. 7, the object position and actual size calculation unit 55 uses information input from the object distance calculation unit 54, that is:

a camera-imaged image (imaged image of the forward camera 41);

correspondence data between an object ID and an object image size;

object distance information; and

these data so as to calculate an actual size that is the actual size of the object.

As described above, the object position and actual size calculation unit 55 calculates the actual size of the object included in the imaged image of the forward camera 41, and stores the calculated object actual size in association with the object ID and object feature information in the object information storage unit 56.

Data stored in the object information storage unit 56 is the data described above with reference to FIG. 5 and is corresponding data of the following pieces of data.

The pieces of information, which are

object ID,

object actual size, and

object feature information (color, shape, pattern, and so on),

are recorded as corresponding data in each object unit.

Note that all of these are objects whose distances are measured by the distance sensor 40, and are objects included in an image imaged by the forward camera 41 in the present embodiment.

[3-2. Example of Distance and Position Calculation Process for Object Included in Camera-Imaged Image Other than Forward Direction]

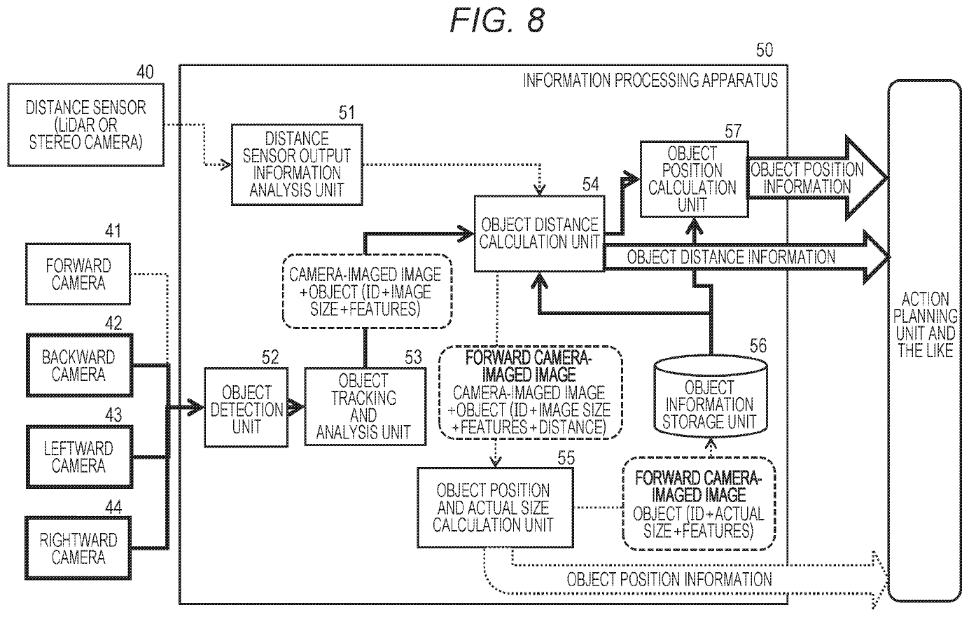

Next, with reference to FIG. 8, an example of distance and position calculation process for an object included in an imaged image of a camera other than the forward camera 41, that is, one of the backward camera 42, or the leftward camera 43, or the rightward camera 44 will be described.

As described above, in a case where a camera-imaged image input from the object tracking and analysis unit 53 of the information processing apparatus 50 illustrated in FIG. 8 is an imaged image of the backward camera 42, the leftward camera 43, or the rightward camera 44 other than the forward camera 41, an object included in the camera-imaged image is outside the distance measurable area of the distance sensor 40, and the distance to the object cannot be calculated using measurement information of the distance sensor.

In this case, the object distance calculation unit 54 calculates the distance to the object using input information from the object tracking and analysis unit 53, that is, a camera-imaged image and correspondence data of an object ID, an object image size, and

object feature information and stored information in the object information storage unit 56.

FIG. 8 is a diagram describing an example of process in a case where the information processing apparatus 50 inputs an imaged image of a camera other than the forward camera 41, that is, one of the backward camera 42, or the leftward camera 43, or the rightward camera 44, and calculates the distance of the object included in an imaged image of these cameras.

In FIG. 8, a flow of data that occurs when an imaged image of one of the backward camera 42, the leftward camera 43, or the rightward camera 44 is input is indicated by a thick arrow.

Note that a process of the information processing apparatus 50 inputting an imaged image of a camera other than the forward camera 41 is a common process, and thus a process in a case where an imaged image of the rightward camera 44 is input will be described below as a representative example.

Specifically, for example, a process in a case where an object (oncoming vehicle 30) as described above with reference to FIG. 3 is imaged by the rightward camera 44 will be described.

Having input an imaged image of the rightward camera 44, the object detection unit 52 of the information processing apparatus 50 illustrated in FIG. 8 detects an object from the image.

The object includes all objects that can be an obstacle to movement of the moving apparatus 10, such as a vehicle, a pedestrian, or a card rail.

The object tracking and analysis unit 53 executes a tracking process of an object detected by the object detection unit 52, sets an object ID for each object, and moreover obtains an object image size (for example, the number of vertical (h)×horizontal (w) pixels) and feature information (color, shape, pattern, and the like) of the object.

Note that the object tracking and analysis unit 53 sets the same object ID for objects that are imaged by the forward camera 41 in advance and to which an object ID is set among objects imaged by the rightward camera 44.

The object tracking and analysis unit 53 holds corresponding pixel position information of a boundary region between the forward camera 41 and the rightward camera 44, and if an object imaged by the forward camera 41 passes through a corresponding pixel position thereof and moves to the rightward camera 44, the same object ID is set to this object.

The object tracking and analysis unit 53 performs a process of setting the same identifier (ID) for imaged objects of two cameras that images adjacent images.

The object tracking and analysis unit 53

outputs correspondence data of the object ID, the object image size, and the object feature information to the object distance calculation unit 54 together with the camera-imaged image.

The object distance calculation unit 54 inputs, from the object tracking and analysis unit 53 and the object information storage unit 56, the following pieces of information:

(a) a rightward camera-imaged image and correspondence data of an object ID of an object included in the image, an object image size, and object feature information from the object tracking and analysis unit 53; and

(b) data recorded in the storage unit, that is, correspondence data of an object ID, an object actual size, and object feature information corresponding to an object imaged by the forward camera from the object information storage unit 56.

The object distance calculation unit 54 inputs these pieces of information, and first confirms whether or not the same ID as the object ID input from the object tracking and analysis unit 53 is stored in the object information storage unit 56.

If the same ID as the object ID input from the object tracking and analysis unit 53 is stored in the object information storage unit 56, features of the object of the rightward camera-imaged image input from the object tracking and analysis unit 53 and feature information of an object to which the same ID is set that is already stored in the object information storage unit 56 are compared.

If the features of the object of the rightward camera-imaged image match the feature information of the object to which the same ID is set that is stored in the object information storage unit 56, it is determined that an ID setting process has been performed correctly, and it is further determined whether or not an actual size corresponding to the object ID is recorded in the object information storage unit 56.

If the feature information of the object matches and the actual size corresponding to the object ID is recorded, an object distance calculation process described below is performed.

In a case where the same ID as the object ID input from the object tracking and analysis unit 53 is not stored in the object information storage unit 56, or

a case where the feature information of the object does not match, or

a case where the actual size of the object is not recorded,

it is determined that the ID setting process or the previous object actual size calculation process has not been performed correctly, and the object distance calculation process described below is not performed.

In this case, a size estimation process based on object features of the image is performed. This process will be described later with reference to a flowchart.

If the object ID of the image object input from the object tracking and analysis unit 53, the object actual size corresponding to the same object ID, and the object feature information are stored in the object information storage unit 56, the object distance calculation unit 54 calculates the distance to the object on the basis of input information from the object tracking and analysis unit 53 and the object information storage unit 56.

That is, the object distance calculation unit 54 calculates the distance to the object using the following pieces of information:

(a) a rightward camera-imaged image input from the object tracking and analysis unit 53; and

(b) data recorded in the storage unit from the object information storage unit 56, that is, object actual size information corresponding to the same object imaged by the forward camera.

Details of this process will be described later.

Having calculated the distance to the object of the detected object from the imaged image of the rightward camera 44, the object distance calculation unit 54 outputs the calculated distance to the object to a module that uses an object distance, such as the action planning unit that sets a movement path (path) of the moving apparatus for example.

The action planning unit provided in the moving apparatus 10 refers to the distance to the object calculated by the object distance calculation unit 54, and sets the movement path so as not to contact an object such as an oncoming vehicle passing in the rightward direction and performs traveling.

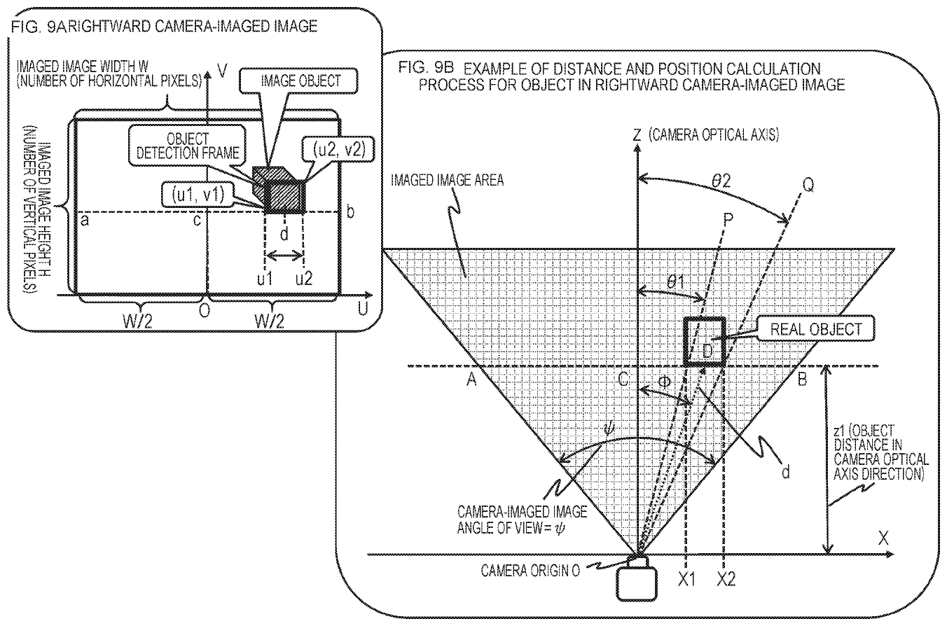

Next, details of the object distance calculation process in the object distance calculation unit 54 will be described with reference to FIG. 9.

As described above, the object distance calculation unit 54 calculates the distance to the object using the following pieces of information:

(a) a rightward camera-imaged image input from the object tracking and analysis unit 53; and

(b) data recorded in the storage unit from the object information storage unit 56, that is, object actual size information corresponding to the same object imaged by the rightward camera.

FIG. 9 illustrates the following diagrams.

(1) A rightward camera-imaged image

(2) An example of distance and position calculation process of object in rightward camera-imaged image

In the rightward camera-imaged image in FIG. 9(1), a horizontal axis corresponding to horizontal pixels of the image is a U axis, and a vertical axis corresponding to vertical pixels of the image is a V axis. An imaged image is an image in which:

the number of vertical pixels=H; and

the number of horizontal pixels=W.

An origin O is set at a lower end of the vertical pixels and a midpoint position of the number of horizontal pixels W.

An object (image object) is imaged in this image.

This image object corresponds to, for example, the oncoming vehicle 30 illustrated in FIG. 3.

An object detection frame is illustrated on a front face of the image object.

The object detection frame has:

coordinates (u1, v1) at a lower left corner of the object detection frame; and

coordinates (u2, v2) at an upper right corner of the object detection frame.

The coordinates (u1, v1) and (u2, v2) indicating an object area are coordinate information that can be obtained from the camera-imaged image.

An XZ coordinate space illustrated in the example of the distance and position calculation process of the object in the rightward camera-imaged image illustrated in FIG. 9(2) corresponds to a real space.

With a camera position of the rightward camera being the origin (camera origin O), an axis perpendicular to the camera imaging direction (rightward direction of the moving apparatus 10) is a horizontal axis X axis, and a Z axis illustrated as a vertical axis in the diagram corresponds to a camera optical axis (camera imaging direction). A value on the Z-axis corresponds to a distance (depth) in a vertical direction from the camera.

A real object illustrated in FIG. 9(2) is an object imaged in the image in FIG. 9(1).

The real object is in the rightward camera image imaging area. However, it is not in the distance sensor measurement area.

A front face (camera side) of a real object position is at a position of z1 in the Z-axis (camera optical axis) direction from the camera origin, and has an X coordinate in the range of X1, X2.

A distance from the camera origin O to the object (center D of the front face X1 to X2), that is, an object distance OD is:

object distance OD=d.

This object distance d is an object distance d as a calculation target.

Note that

an angle of view of camera-imaged image=ψ

is a known value.

An image on a segment ab parallel to the U axis passing through the object on the image in FIG. 9(1) corresponds to an image of a segment AB passing through the front face of the object in the real space in FIG. 9(2) (the segment AB parallel to the X axis on Z=z1).

That is, an image obtained by reducing an actual size of the line AB in the real space corresponds to an image of the line ab in an image space.

Therefore, the position of the image object on the segment ab of the rightward camera-imaged image in FIG. 9(1) and the position of the real object on the segment AB of the real space in FIG. 9(2) are in a same positional relationship.

Under these conditions, the distance d of the real object in the real space is calculated.

A calculation process of the real object distance d illustrated in FIG. 9(2) is performed by sequentially executing the following processes B1 to B3.

(Process B1) An angle Φ formed by a straight line OD (a straight line indicated as the object distance d in the diagram) connecting the camera origin O to the object front-face center D and the Z axis (camera optical axis) in the real space is calculated.

(Process B2) A separation distance from the camera origin O in the Z-axis (camera optical axis) direction in the real space, that is, a Z coordinate z1 of the real object is calculated.

(Process B3) The object distance d is calculated using the values calculated in the processes B1 and B2.

Hereinafter, details of each of the above-described (Process B1) to (Process B3) will be described.

(Process B1)

First, a process B1, that is, a calculation process of an angle Φ formed by a straight line OD (a straight line indicated as the object distance d in the diagram) connecting the camera origin O to the object front-face center D and the Z axis (camera optical axis) in the real space will be described.

A center point of the segment ab in the image in FIG. 9(1) is c, and a center point of the image object in the segment ab is d.

On the other hand, a center point of the segment AB in the real space in FIG. 9(2) is C, and a center point of the real object in the segment AB is D.

Further, U coordinates of left and right end points of the image object in the segment ab in the image in FIG. 9(1) are u1, u2.

At this time, a ratio of cb and cd and a ratio of CB and CD are the same, and

cb:cd=CB:CD (Equation 21),

above-described (Equation 21) holds.

From above-described (Equation 21), following (Equation 22) is obtained.

W/2:(u1+u2)/2=tan (ψ/2):tan Φ (Equation 22)

In above-described (Equation 22),

W represents the number of horizontal pixels of the rightward camera-imaged image,

u1, u2 represent coordinate information of the image object of the rightward camera-imaged image, and

ψ represents an angle of view of the rightward camera,

all of which are known values.

Therefore, from above-described (Equation 22), the angle Φ, that is, the angle Φ formed by the straight line OD (the straight line indicated as the object distance d in the diagram) connecting the camera origin O to the object front-face center D and the Z axis (camera optical axis) can be calculated.

(Process B2)

Next, a process B2, that is, a process of calculating a separation distance from the camera origin O in the Z-axis (camera optical axis) direction in the real space, that is, a Z coordinate=z1 of the real object will be described.

In the real space illustrated in FIG. 9(2),

CB=z1×tan(ψ/2) (Equation 23),

and

z1=CB/(tan (ψ/2)) (Equation 24).

Here, a length CB in the real space illustrated in FIG. 9(2) is reduced to a length cb (=W/2) in the image space illustrated in FIG. 9(1).

This reduction ratio is equal to a reduction ratio of the following sizes,

a size (width)=(X2−X1) of the real object in the real space, and

a size (width)=(u2−u1) of the image object in the image space.

Therefore, CB in above-described (Equation 24) can be calculated by following (Equation 25).

CB=(W/2)×(X2−X1)/(u2−u1) (Equation 25)

From above-described (Equation 25), above-described (Equation 24) can be expressed as following (Equation 26).

z1=((W/2)×(X2−X1)/(u2−u1))/(tan(ψ/2)) (Equation 26)

In (Equation 26) described above,

W/2 represents half the number of horizontal pixels of the imaged image and is known.

(X2−X1) is a size (width) of the real object, and is a value stored in advance in the object information storage unit 56.

(u2−u1) can be obtained from the imaged image.

(tan(W/2)) can be calculated from the angle of view T.

Therefore, the separation distance of the real object from the camera origin O in the Z axis (camera optical axis) direction, that is, the Z coordinate=z1 of the real object can be calculated according to above-described (Equation 26) using these known values.

Note that (X2−X1) is the size (width) of the real object, which is a value calculated by applying the imaged image of the forward camera 41 and stored in the object information storage unit 56. Therefore, for example, in a case where the object is an oncoming vehicle, the object size (width) previously stored in the object information storage unit 56 corresponds to the width of a front portion of the oncoming vehicle imaged by the front camera.

On the other hand, the image illustrated in FIG. 9(1) is an image imaged by the rightward camera, and the object width may correspond to the length of the vehicle when the oncoming vehicle is viewed from the side. In such a case, if the size (width) X2−X1 of the real object is applied as it is, an error may occur in the calculated value.

In order to reduce this problem, for the size (width) X2−X1 of the real object applied in (Equation 26) described above, a configuration to use a value converted using a conversion formula set in advance may be employed instead of applying the object size (width) stored in the object information storage unit 56 as it is.

For example, the ratio between a front size and a side size is stored in advance in object type units in the memory.

The object distance calculation unit 54 determines the object type from the object feature, calculates a value obtained by multiplying by the ratio, and takes this value as the size (width) X2−X1 of the real object (Equation 26).

For example,

passenger car=front size 2 m, side size 4 m, side/front ratio=2.0

truck=front size 2.5 m, side size 7.5 m, side/front ratio=3.0

pedestrian=front size 0.5 m, side size 0.3 m, side/front ratio=0.6

A typical size and ratio in such object type units may be stored in advance in the storage unit, and the object distance calculation unit 54 may apply this ratio information to adjust the object actual size X2−X1 of (Equation 26) described above.

(Process B3)

Next, a process B3, that is, a process of calculating the object distance d using the values calculated in the processes B1 and B2 will be described.

In the real space illustrated in FIG. 9(2),

cos Φ=z1/d (Equation 27),

above-described (Equation 27) is established.

From (Equation 27) described above,

following (Equation 28) is derived.

d=z1/cos Φ (Equation 28)

In (Equation 28) described above,

z1 is a value calculated in (Equation 26) of the above-described (Process B2),

Φ is a value that can be calculated by (Equation 22) of (Process B1).

Therefore, the distance d to the real object can be calculated according to above-described (Equation 28).

Moreover, the object position calculation unit 57 calculates the position of the object included in the rightward camera 44.

That is, the object position calculation unit 57 calculates X1, X2, which are values on the X axis of the real object in the real space of FIG. 9(2).

The calculation process of the object position X1, X2 in the object position calculation unit 57 is performed by sequentially executing the following processes C1 and C2.

(Process C1) An angle θ1 formed by the segment OP connecting the camera origin O and the left end (X coordinate=X1) of the front (camera side) of the real object and the Z axis in the real space, and an angle θ2 formed by the segment OQ connecting the camera origin O and the right end (X coordinate=X2) of the front (camera side) of the real object and the Z axis, are calculated.

(Process C2) The object position X1, X2 is calculated using the values calculated in the process C1.

Hereinafter, details of the (Process C1) and (Process C2) will be described with reference to FIG. 9.

(Process C1)

First, a process C1, that is, a calculation process of an angle θ1 formed by the segment OP connecting the camera origin O and the left end (X coordinate=X1) of the front (camera side) of the real object and the Z axis in the real space, and an angle θ2 formed by the segment OQ connecting the camera origin O and the right end (X coordinate=X2) of the front (camera side) of the real object and the Z axis, will be described.

As described above, an image on the segment ab parallel to the U axis passing through the object on the image in FIG. 9(1) corresponds to an image on the segment AB passing through the front face of the object in the real space in FIG. 9(2) (the segment AB parallel to the X axis on Z=z1).

That is, an image obtained by reducing an actual size of the line AB in the real space corresponds to an image of the line ab in an image space.

Therefore, the u-coordinates u1, u2 of the end points of the image object position in the segment ab of the forward camera-imaged image in FIG. 9(1) and the X coordinates X1, X2 of the end points of the real object position in the segment AB of the real space in FIG. 9(2) are in the same positional relationship.

From this relationship, as correspondences among respective values of:

a length cb from c to b,

a length cu1 from c to u1, and

a length cu2 from c to u2

in the image in FIG. 9(1); and

a length CB from C to B,

a length CX1 from C to X1, and

a length CX2 from C to X2

in the real space in FIG. 9(2),

following (Equation 31) and (Equation 32) hold.

cb:cu1=CB:CX1 (Equation 31)

cb:cu2=CB:CX2 (Equation 32)

Above-described (Equation 31) and (Equation 32) hold.

From (Equation 31) and (Equation 32) described above,

W/2:cu1=tan (ψ/2):tan(θ1) (Equation 33)

W/2:cu2=tan (ψ/2):tan(θ2) (Equation 34)

are obtained.

In above-described (Equation 33), an unknown is only θ1, and thus θ1 can be calculated from (Equation 33).

Further, in above-described (Equation 34), an unknown is only 62, and thus 62 can be calculated from (Equation 34).

(Process C2)

Next, a process C2, that is, a process of calculating the object position X1, X2 using the value calculated in the process C1 will be described.

A relationship among the X coordinate=X1 of the left end of the front (camera side) of the real object illustrated in FIG. 9(2),

the Z coordinate=z1 of the real object,

the angle=θ1 formed by the segment OP and the Z axis,

can be expressed by following (Equation 35).

X1=z1×sin θ1 (Equation 35)

Similarly, a relationship among the X coordinate=X2 of the right end of the front (camera side) of the real object,

the Z coordinate=z1 of the real object,

the angle=θ2 formed by the segment OQ and the Z axis,

can be expressed by following (Equation 36).

X2=z1×sin θ2 (Equation 36)

In above-described (Equation 35) and (Equation 36), z1 is calculated by the object distance calculation unit 54 according to (Equation 26) described above and is known.

Further, θ1, θ2 are calculated according to (Equation 33) and (Equation 34) and are known.

Therefore, from (Equation 35) and (Equation 36) described above,

it is possible to calculate the X coordinates=X1, X2 of the left and right ends of the front (camera side) of the real object.

The object position information X1, X2 is output to and used by a module using object position information such as the action planning unit.

As described above, the information processing apparatus 50 executes the following two processes.

(Process 1. A process for an object in an image in the distance measurable area of the distance sensor)

The object distance calculation unit 54 calculates a distance of an object included in an imaged image of the forward camera 41 that images an image in the distance measurable area of the distance sensor 40 from sensor information of the distance sensor 40.

Moreover, the object position and actual size calculation unit 55 calculates a position and an actual size of the object by applying the processing described above with reference to FIG. 7, that is, the imaged image of the forward camera 41 and the distance information d.

(Process 2. A process for an object in an image in other than the distance measurable area of the distance sensor)

The object distance calculation unit 54 calculates a distance of an object included in an imaged image of a camera (the backward camera, the leftward camera 43, or the rightward camera 44) that images an image outside the distance measurable area of the distance sensor 40, using the imaged image of the camera and object size information stored in the object information storage unit 56.

Further, the object position calculation unit 57 calculates an object position using the imaged image of the camera, the distance to the object in the camera optical axis direction calculated by the object distance calculation unit 54, and object size information stored in the object information storage unit 56.

[4. Sequence of Processes Executed by Information Processing Apparatus]

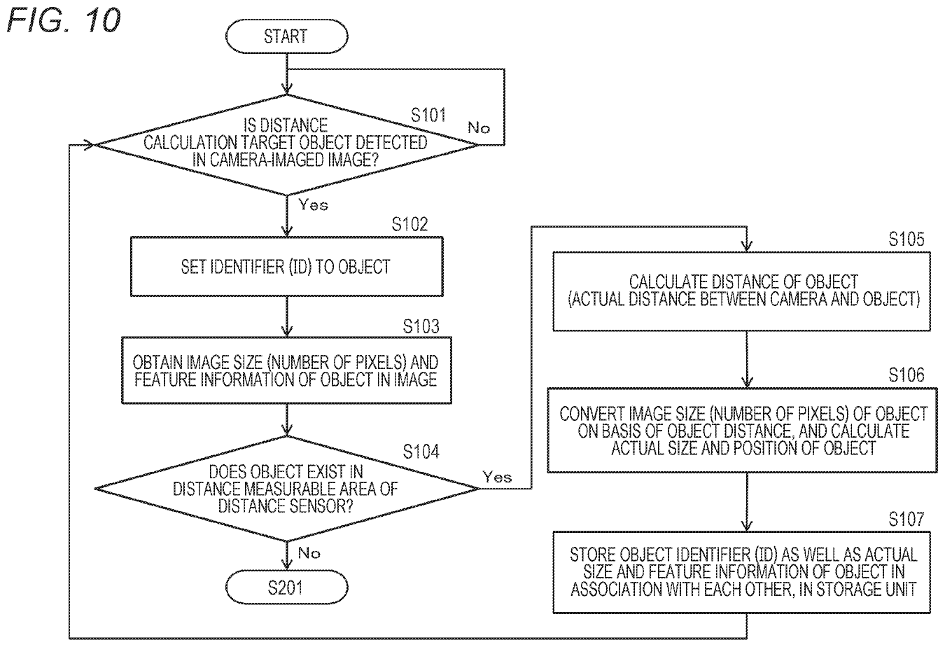

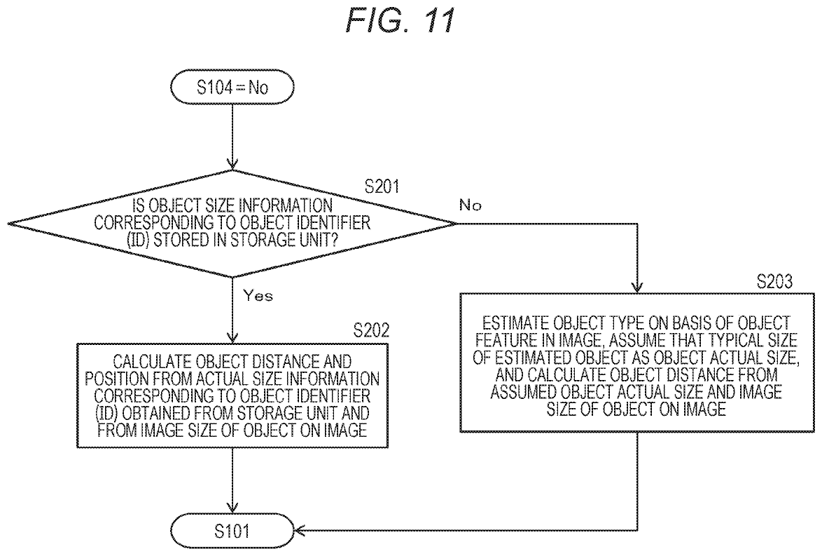

Next, a sequence of processes executed by the information processing apparatus will be described with reference to flowcharts illustrated in FIGS. 10 and 11.

Note that the processes according to the flowcharts illustrated in FIGS. 10 and 11 can be executed, for example, according to a program stored in the storage unit of the information processing apparatus.

The information processing apparatus includes hardware having a program execution function, for example a CPU or the like.

Hereinafter, processes of respective steps of the flowcharts will be described.

(Step S101)

A process in step S101 is a process executed by the object detection unit 52 of the information processing apparatus. In step S101, the object detection unit 52 determines whether or not a distance calculation target object is detected in a camera-imaged image.

Note that the camera in this case is any of the forward camera 41, the backward camera 42, the leftward camera 43, and the rightward camera 44.

Further, the distance calculation target object may be, for example, all objects that can be an obstacle to movement of the moving apparatus 10, such as a pedestrian, a card rail, and a side wall in addition to a vehicle, or may be set in advance so that only a moving object is selected.

(Steps S102 to S103)

Processes in subsequent steps S102 to S103 are processes executed by the object tracking and analysis unit 53.

The object tracking and analysis unit 53 executes a tracking process of an object detected by the object detection unit 52. That is, an identifier (ID) is set to each of objects detected from the images, and each object is tracked according to movement on the image.

Moreover, the object tracking and analysis unit 53 obtains a size (for example, the number of vertical (h) x horizontal (w) pixels) on an image of the object to which the object ID is set and feature information of the object.

The feature information of the object is, for example, features such as a color, a shape, and a pattern of the object.

Note that as described above, the object tracking and analysis unit 53 holds corresponding pixel position information of a boundary region between imaged images of two cameras that image adjacent images, such as the forward camera 41 and the rightward camera 44, and if an object passes through a corresponding pixel position thereof and moves to an imaged image of a different camera, the same object ID is set for this object. In this manner, the object tracking and analysis unit 53 performs the same identifier (ID) setting process for imaging objects of two cameras that images adjacent images.

(Step S104)

A process in step S104 is a process executed by the object distance calculation unit 54.

In step S104, the object distance calculation unit 54 first determines whether or not a distance calculation target object included in the image imaged by the camera is included in the distance measurable area of the distance sensor 40.

That is, in the present embodiment, as described with reference to FIGS. 1 to 3, the distance measurable area of the distance sensor 40 is in the imaging area of the forward camera 41, and if a processing target object is an object of the imaged image of the forward camera 41, determination in step S104 is Yes and the process proceeds to step S105.

On the other hand, if the processing target object is an object of an imaged image of a camera other than the forward camera 41, determination in step S104 is No, and the process proceeds to step S201.

(Step S105)

The processes in steps S105 to S107 are processes executed if the processing target object is an object of an imaged image of the forward camera 41.

The process in step S105 is a process executed by the object distance calculation unit 54.

The processes in steps S106 to S107 are processes executed by the object position and actual size calculation unit 55.

First, in step S105, the object distance calculation unit 54 calculates a distance of the distance calculation target object in the imaged image of the forward camera 41.

This object distance calculation process can be directly calculated from sensor information of the distance sensor 40.

Note that distance information to the object calculated by the object distance calculation unit 54 is output to a module using object information such as the action planning unit.

The module using object information such as the action planning unit provided in the moving apparatus 10 refers to the distance to the object calculated by the object distance calculation unit 54, and sets the movement path so as not to contact an object such as an oncoming vehicle and performs traveling.

(Step S106)

Next, in step S106, the object position and actual size calculation unit 55 calculates an actual size and a position of the distance calculation target object in the imaged image of the forward camera 41.

This process is the process described above with reference to FIG. 7.

That is, the actual size and position of the object are calculated by applying the imaged image of the forward camera 41 and object distance information d calculated by the object distance calculation unit 54.

Object position information calculated by the object position and actual size calculation unit 55 is output to a module using object information such as the action planning unit.

The module using object information such as the action planning unit provided in the moving apparatus 10 refers to the object position calculated by the object position and actual size calculation unit 55, and sets the movement path so as not to contact an object such as an oncoming vehicle and performs traveling.

(Step S107)

In step S107, the object position and actual size calculation unit 55 further stores the actual size of the object calculated in step S106, that is, the actual size of the distance calculation target object in the imaged image of the forward camera 41 in the object information storage unit 56 in association with the identifier (ID) and feature information of the object.

Data stored in the object information storage unit 56 is the data described above with reference to FIG. 5 and is corresponding data of the following pieces of data.

The pieces of information are:

object ID;

object actual size; and

object feature information (color, shape, pattern, and so on) .

are recorded as corresponding data for each object unit.

Note that all of these are objects whose distances are measured by the distance sensor 40, and are objects included in an image imaged by the forward camera 41 in the present embodiment.

When the process in step S107 is completed, the process returns to step S101, and a process for a new object is further executed.

Next, a process when No is determined in the determination process in step S104, that is, a process if the processing target object is an object of an imaged image of a camera other than the forward camera 41 will be described with reference to FIG. 11.

(Step S201)

A process in step S201 is a process executed by the object distance calculation unit 54.

When the processing target object is an object of an imaged image of a camera other than the forward camera 41, the object distance calculation unit 54 first determines, in step S201, whether or not object size information corresponding to the object identifier (ID) is recorded in the object information storage unit 56.

That is, in the process for the imaged image of the forward camera 41 executed in advance, it is confirmed whether or not distance calculation and actual size calculation are executed and calculated actual size information is recorded in the object information storage unit 56 together with the object ID.

Note that as described above, the object tracking and analysis unit 53 holds corresponding pixel position information of a boundary region between imaged images of two cameras that image adjacent images, such as the forward camera 41 and the rightward camera 44, and if an object passes through a corresponding pixel position thereof and moves to an imaged image of a different camera, the same object ID is set for this object.

Therefore, if the actual size calculation is executed in the process for the imaged image of the forward camera 41 executed previously, actual size information thereof is recorded in the object information storage unit 56 in association with the same object ID as the object ID of the object set as the current processing target.

However, if some kind of error occurs in the process for the imaged image of the forward camera 41, or if a size calculation failure or the like occurs, it is possible that the actual size data is not stored in the storage unit.

If the object distance calculation unit 54 confirms that the object size information corresponding to the object identifier (ID) is recorded in the object information storage unit 56 in step S201, the process proceeds to step S202.

On the other hand, if it is confirmed that the object size information corresponding to the object identifier (ID) is not recorded in the object information storage unit 56, the process proceeds to step S203.

(Step S202)

A process in step S202 is a process executed by the object distance calculation unit 54 and the object position calculation unit 57.

If it is confirmed in step S201 that the object size information corresponding to the object identifier (ID) is recorded in the object information storage unit 56, in step S202, the object distance calculation unit 54 calculates a distance of the object, and furthermore the object position calculation unit 57 calculates an object position.

This process is the process described above with reference to FIG. 9. That is, the object distance calculation unit 54 calculates a distance of an object included in an imaged image of a camera (the backward camera, the leftward camera 43, or the rightward camera 44) that images an image outside the distance measurable area of the distance sensor 40, using the imaged image of the camera and object size information stored in the object information storage unit 56.

Further, the object position calculation unit 57 calculates an object position using the imaged image of the camera, the distance to the object calculated by the object distance calculation unit 54, and object size information stored in the object information storage unit 56.

The distance and position of the object calculated by the object distance calculation unit 54 and the object position calculation unit 57 are output to a module using object information such as the action planning unit.

The module using object information such as the action planning unit provided in the moving apparatus 10 refers to the input distance to and position of the object, and sets the movement path so as not to contact an object such as an oncoming vehicle and performs traveling.

(Step S203)

A process of step S203 is a process executed by the object distance calculation unit 54 and the object position calculation unit 57 if it is confirmed in step S201 that the object size information corresponding to the object identifier (ID) is not recorded in the object information storage unit 56.

In step S203, the object distance calculation unit 54 and the object position calculation unit 57 estimate an object type on the basis of an object feature in the image, assume a typical size of the estimated object as an object actual size, and calculate a distance to and a position of the object from the assumed object actual size and the distance to and position of the object from an image size of the object on the image.

That is, first, the object distance calculation unit 54 and the object position calculation unit 57 specify the object type on the basis of the object feature in the image.

For example, the object is a passenger car on the basis of the object feature. Alternatively, the object type such as a track or a pedestrian is estimated.

Note that typical sizes according to the type of object, for example:

passenger car=width 2 m;

track=width 3 m; and

pedestrian=width 0.5 m.

Such typical sizes in object type units are stored in the storage unit in advance.

The object distance calculation unit 54 and the object position calculation unit 57 obtain a typical size corresponding to the object type estimated on the basis of the object feature from the storage unit.

The object distance calculation unit 54 and the object position calculation unit 57 apply the typical size obtained from the storage unit as actual size information of the object, and execute the processes described above with reference to FIG. 9, so as to calculate the distance and the position of the object.

The distance and position of the object calculated by the object distance calculation unit 54 and the object position calculation unit 57 are output to a module using object information such as the action planning unit.

The module using object information such as the action planning unit provided in the moving apparatus 10 refers to the input distance to and position of the object, and sets the movement path so as not to contact an object such as an oncoming vehicle and performs traveling.

[5. Configuration Example of Moving Apparatus]

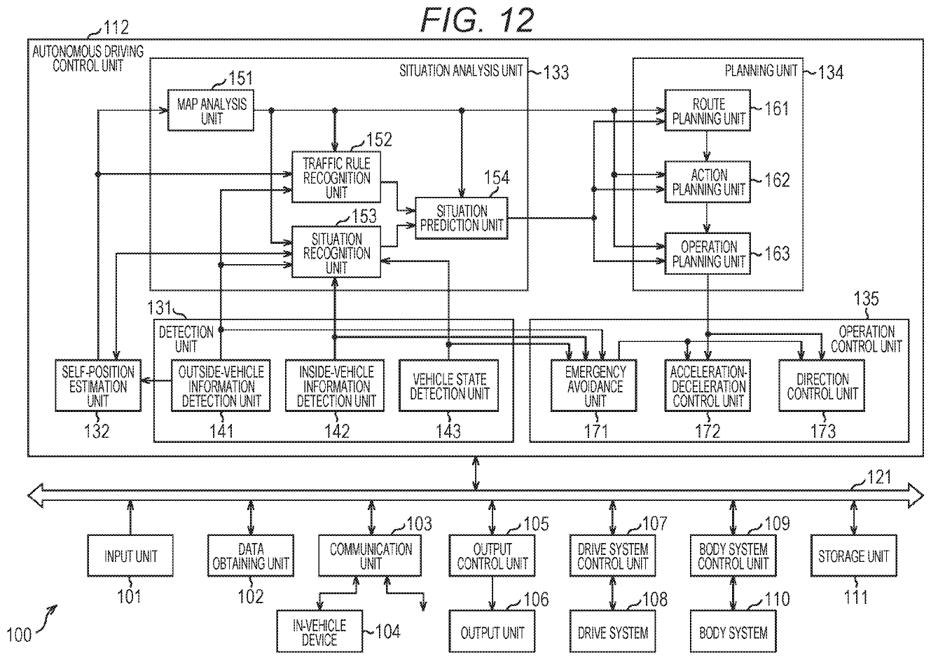

Next, a configuration example of the moving apparatus will be described with reference to FIG. 12.

FIG. 12 is a block diagram illustrating a schematic functional configuration example of a vehicle control system 100 that is an example of a moving body control system that can be mounted in a moving apparatus that performs the above-described processing.

Note that, hereinafter, in a case where a vehicle provided with the vehicle control system 100 is distinguished from other vehicles, it will be referred to as an own car or an own vehicle.

The vehicle control system 100 includes an input unit 101, a data obtaining unit 102, a communication unit 103, an in-vehicle device 104, an output control unit 105, an output unit 106, a drive system control unit 107, a drive system 108, a body system control unit 109, a body system 110, a storage unit 111, and an autonomous driving control unit 112. The input unit 101, the data obtaining unit 102, the communication unit 103, the output control unit 105, the drive system control unit 107, the body system control unit 109, the storage unit 111, and the autonomous driving control unit 112 are connected to each other via a communication network 121. The communication network 121 is, for example, an in-vehicle communication network, a bus, or the like, that conforms to any standard such as Controller Area Network (CAN), Local Interconnect Network (LIN), Local Area Network (LAN), or FlexRay (registered trademark). Note that each unit of the vehicle control system 100 may be directly connected without passing through the communication network 121.

Note that, hereinafter, in a case where each unit of the vehicle control system 100 performs communication via the communication network 121, description of the communication network 121 is omitted. For example, in a case where the input unit 101 and the autonomous driving control unit 112 perform communication via the communication network 121, it is simply described that the input unit 101 and the autonomous driving control unit 112 perform communication.

The input unit 101 includes a device used by a passenger for inputting various data and instructions and the like. For example, the input unit 101 includes operating devices such as a touch panel, a button, a microphone, a switch, and a lever, an operating device that allows input by a method other than manual operation by a voice, a gesture, or the like, and the like. Further, for example, the input unit 101 may be a remote control device using infrared rays or other radio waves, or an externally connected device such as a mobile device or a wearable device corresponding to operation of the vehicle control system 100. The input unit 101 generates an input signal on the basis of data or instructions or the like input by the passenger and supplies the input signal to each unit of the vehicle control system 100.

The data obtaining unit 102 includes various sensors or the like that obtain data used for processing of the vehicle control system 100, and supplies the obtained data to each unit of the vehicle control system 100.

For example, the data obtaining unit 102 includes various sensors for detecting a state or the like of the own vehicle. Specifically, for example, the data obtaining unit 102 includes a gyro sensor, an acceleration sensor, an inertial measurement device (IMU), and a sensor or the like for detecting an operation amount of an accelerator pedal, an operation amount of a brake pedal, a steering angle of a steering wheel, an engine speed, a motor rotation speed, or a rotation speed of the wheel, or the like.

Further, for example, the data obtaining unit 102 includes various sensors for detecting information outside the own vehicle. Specifically, for example, the data obtaining unit 102 includes an image capturing device such as a ToF (Time of Flight) camera, a stereo camera, a monocular camera, an infrared camera, and other cameras. Further, for example, the data obtaining unit 102 includes an environment sensor for detecting weather or climate or the like and a surrounding information detection sensor for detecting objects around the own vehicle. The environmental sensor includes, for example, a raindrop sensor, a fog sensor, a sunshine sensor, a snow sensor, and the like. The surrounding information detection sensor includes, for example, an ultrasonic sensor, a radar, a LiDAR (Light Detection and Ranging, Laser Imaging Detection and Ranging), a sonar, and the like.

Moreover, for example, the data obtaining unit 102 includes various sensors for detecting a current position of the own vehicle. Specifically, for example, the data obtaining unit 102 includes a GNSS receiver or the like that receives a GNSS signal from a global navigation satellite system (GNSS) satellite.

Further, for example, the data obtaining unit 102 includes various sensors for detecting information in the vehicle. Specifically, for example, the data obtaining unit 102 includes an image capturing device that captures an image of a driver, a biological sensor that detects biological information of the driver, a microphone that collects sound in a vehicle interior, and the like. The biometric sensor is provided on, for example, a seat surface or a steering wheel or the like, and detects biological information of a passenger sitting on the seat or a driver holding the steering wheel.

The communication unit 103 communicates with the in-vehicle device 104 and various devices, a server, a base station, and the like outside the vehicle, transmits data supplied from each unit of the vehicle control system 100, and supplies received data to each unit of the vehicle control system 100. Note that a communication protocol supported by the communication unit 103 is not particularly limited, and the communication unit 103 can support a plurality of types of communication protocols.

For example, the communication unit 103 performs wireless communication with the in-vehicle device 104 by wireless LAN, Bluetooth (registered trademark), Near Field Communication (NFC), Wireless USB (WUSB), or the like. Further, for example, the communication unit 103 performs wired communication with the in-vehicle device 104 by a Universal Serial Bus (USB), High-Definition Multimedia Interface (HDMI) (registered trademark), Mobile High-definition Link (MHL), or the like via a connection terminal (and a cable if necessary).

Moreover, for example, the communication unit 103 communicates with a device (for example, an application server or a control server) existing on an external network (for example, the Internet, a cloud network, or an operator-specific network) via a base station or an access point. Further, for example, the communication unit 103 uses Peer-to-peer (P2P) technology to communicate with a terminal (for example, a terminal of a pedestrian or a store, or a machine-type communication (MTC) terminal) that exists in the vicinity of the own vehicle. Moreover, for example, the communication unit 103 performs V2X communication such as vehicle-to-vehicle communication, vehicle-to-infrastructure communication, vehicle-to-home communication, and vehicle-to-pedestrian communication). Further, for example, the communication unit 103 includes a beacon receiving unit and receives radio waves or electromagnetic waves transmitted from wireless stations or the like installed on the road, and obtains information such as current position, traffic jam, traffic regulation, or the time required.

The in-vehicle device 104 includes, for example, a mobile device or a wearable device possessed by a passenger, an information device that is carried in or attached to the own vehicle, and a navigation device or the like that searches for a route to an arbitrary destination.

The output control unit 105 controls output of various information to a passenger of the own vehicle or the outside of the vehicle. For example, the output control unit 105 generates an output signal including at least one of visual information (for example, image data) and auditory information (for example, audio data), and supplies the output signal to the output unit 106, so as to control output of visual and auditory information from the output unit 106. Specifically, for example, the output control unit 105 generates an overhead image or a panoramic image or the like by combining image data captured by different image capturing devices of the data obtaining unit 102, and supplies an output signal including the generated image to the output unit 106. Further, for example, the output control unit 105 generates sound data including a warning sound or a warning message for danger such as a collision, contact, entry into a dangerous zone, or the like, and supplies an output signal including the generated sound data to the output unit 106.

The output unit 106 includes a device capable of outputting visual information or auditory information to a passenger of the own vehicle or the outside of the vehicle. For example, the output unit 106 includes a display device, an instrument panel, an audio speaker, headphones, a wearable device such as a glasses-type display worn by a passenger, a projector, a lamp, and the like. Other than a device having a normal display, the display device provided in the output unit 106 may be a device that displays visual information in the visual field of the driver such as, for example, a head-up display, a transmission type display, or a device having an augmented reality (AR) display function.

The drive system control unit 107 controls the drive system 108 by generating various control signals and supplying them to the drive system 108. Further, the drive system control unit 107 supplies a control signal to each unit other than the drive system 108 as necessary, and performs notification of a control state of the drive system 108, or the like.

The drive system 108 includes various devices related to the drive system of the own vehicle. For example, the drive system 108 includes a driving force generator for generating a driving force, such as an internal combustion engine or a driving motor, a driving force transmission mechanism for transmitting the driving force to wheels, a steering mechanism for adjusting a steering angle, a braking device that generates a braking force, an antilock brake system (ABS), an electronic stability control (ESC), an electric power steering device, and the like.

The body system control unit 109 controls the body system 110 by generating various control signals and supplying them to the body system 110. Further, the body system control unit 109 supplies a control signal to each unit other than the body system 110 as necessary, and performs notification of a control state of the body system 110, or the like.

The body system 110 includes various body devices that are mounted on the vehicle body. For example, the body system 110 includes a keyless entry system, a smart key system, a power window device, a power seat, a steering wheel, an air conditioner, and various lamps (for example, a head lamp, a back lamp, a brake lamp, a blinker, a fog lamp, and the like), and the like.

The storage unit 111 includes, for example, a read only memory (ROM), a random access memory (RAM), a magnetic storage device such as a Hard Disc Drive (HDD), a semiconductor storage device, an optical storage device, a magneto-optical storage device, and the like. The storage unit 111 stores various programs, data, and the like, used by each unit of the vehicle control system 100. For example, the storage unit 111 stores map data of a three-dimensional high-precision map such as a dynamic map, a global map that is less accurate than the high-precision map and covers a wide area, a local map that includes information around the own vehicle, and the like.

The autonomous driving control unit 112 performs control related to autonomous driving such as autonomous driving or driving support. Specifically, for example, the autonomous driving control unit 112 performs cooperative control for the purpose of achieving Advanced Driver Assistance System (ADAS) functions including collision avoidance or impact mitigation of the own vehicle, follow-up traveling based on the inter-vehicle distance, vehicle speed maintenance traveling, own vehicle collision warning, own vehicle lane departure warning, or the like. Further, for example, the autonomous driving control unit 112 performs cooperative control for the purpose of autonomous driving or the like to autonomously travel without depending on operation of the driver. The autonomous driving control unit 112 includes a detection unit 131, a self-position estimation unit 132, a situation analysis unit 133, a planning unit 134, and an operation control unit 135.

The detection unit 131 detects various information necessary for controlling autonomous driving. The detection unit 131 includes an outside-vehicle information detection unit 141, an inside-vehicle information detection unit 142, and a vehicle state detection unit 143.

The outside-vehicle information detection unit 141 performs a detection process of information outside the own vehicle on the basis of data or signals from each unit of the vehicle control system 100. For example, the outside-vehicle information detection unit 141 performs a detection process, a recognition process, and a tracking process of an object around the own vehicle, and a detection process of distance to an object around the own vehicle. Examples of objects to be detected include vehicles, people, obstacles, structures, roads, traffic lights, traffic signs, road markings, and the like. Further, for example, the outside-vehicle information detection unit 141 performs a detection process of a surrounding environment of the own vehicle. The surrounding environment to be detected includes, for example, weather, temperature, humidity, brightness, road surface condition, and the like. The outside-vehicle information detection unit 141 supplies data indicating results of detection processes to the self-position estimation unit 132, a map analysis unit 151, a traffic rule recognition unit 152, and a situation recognition unit 153 of the situation analysis unit 133, an emergency avoidance unit 171 of the operation control unit 135, and the like.

The inside-vehicle information detection unit 142 performs a detection process of inside-vehicle information on the basis of data or signals from each unit of the vehicle control system 100. For example, the inside-vehicle information detection unit 142 performs an authentication process and a recognition process of a driver, a state detection process of the driver, a detection process of a passenger, a detection process of in-vehicle environment, and the like. The state of the driver to be detected includes, for example, physical condition, awakening level, concentration level, fatigue level, line-of-sight direction, and the like. The in-vehicle environment vehicle to be detected includes, for example, temperature, humidity, brightness, smell, and the like. The inside-vehicle information detection unit 142 supplies data indicating results of detection processes to the situation recognition unit 153 of the situation analysis unit 133, the emergency avoidance unit 171 of the operation control unit 135, and the like.

The vehicle state detection unit 143 performs a detection process of the state of the own vehicle on the basis of data or signals from each unit of the vehicle control system 100. The state of the own vehicle to be detected includes, for example, speed, acceleration, steering angle, presence or absence and content of abnormality, driving operation state, position and inclination of power seat, door lock state, and states of other in-vehicle devices, and the like. The vehicle state detection unit 143 supplies data indicating results of detection processes to the situation recognition unit 153 of the situation analysis unit 133, the emergency avoidance unit 171 of the operation control unit 135, and the like.

The self-position estimation unit 132 performs an estimation process of the position, posture, and the like of the own vehicle on the basis of data or signals from respective units of the vehicle control system 100 such as the outside-vehicle information detection unit 141 and the situation recognition unit 153 of the situation analysis unit 133. Further, the self-position estimation unit 132 generates a local map (hereinafter, referred to as a self-position estimation map) used for self-position estimation as necessary. The self-position estimation map is, for example, a highly accurate map using a technique such as simultaneous localization and mapping (SLAM). The self-position estimation unit 132 supplies data indicating a result of the estimation process to the map analysis unit 151, the traffic rule recognition unit 152, and the situation recognition unit 153 of the situation analysis unit 133, and the like. Further, the self-position estimation unit 132 stores the self-position estimation map in the storage unit 111.

The situation analysis unit 133 performs an analysis process of the own vehicle and the surrounding situation. The situation analysis unit 133 includes a map analysis unit 151, a traffic rule recognition unit 152, a situation recognition unit 153, and a situation prediction unit 154.

The map analysis unit 151 performs an analysis process of various types of maps stored in the storage unit 111 using data or signals from each unit of the vehicle control system 100 such as the self-position estimation unit 132 and the outside-vehicle information detection unit 141 as necessary, and constructs a map that contains information necessary for processing of autonomous driving. The map analysis unit 151 supplies the constructed map to the traffic rule recognition unit 152, the situation recognition unit 153, the situation prediction unit 154, and a route planning unit 161, an action planning unit 162, and an operation planning unit 163 of the planning unit 134, and the like.

The traffic rule recognition unit 152 performs a recognition process of traffic rules around the own vehicle on the basis of data or signals from each unit of the vehicle control system 100 such as the self-position estimation unit 132, the outside-vehicle information detection unit 141, and the map analysis unit 151. By this recognition process, for example, positions and states of traffic signals around the own vehicle, contents of traffic restrictions around the own vehicle, lanes that can be traveled, and the like are recognized. The traffic rule recognition unit 152 supplies data indicating a recognition processing result to the situation prediction unit 154 and the like.

The situation recognition unit 153 performs a recognition process of a situation related to the own vehicle on the basis of data or signals from each unit of the vehicle control system 100 such as the self-position estimation unit 132, the outside-vehicle information detection unit 141, the inside-vehicle information detection unit 142, the vehicle state detection unit 143, and the map analysis unit 151. For example, the situation recognition unit 153 performs a recognition process of a situation of the own vehicle, a situation around the own vehicle, a situation of the driver of the own vehicle, and the like. Further, the situation recognition unit 153 generates a local map (hereinafter referred to as a situation recognition map) used for recognizing the situation around the own vehicle as necessary. The situation recognition map is, for example, an occupancy grid map.

The situation of the own vehicle to be recognized includes, for example, position, posture, and movement (for example, speed, acceleration, moving direction, and the like) of the own vehicle, presence or absence and content of abnormality, and the like. The situation around the own vehicle to be recognized includes, for example, type and position of a surrounding stationary object, type, position, and movement of a surrounding moving object (for example, speed, acceleration, moving direction, and the like), configuration and road surface condition of a surrounding road, ambient weather, temperature, humidity, brightness, and the like. The state of the driver to be recognized includes, for example, physical condition, awakening level, concentration level, fatigue level, line-of-sight movement, driving operation, and the like.

The situation recognition unit 153 supplies data (including the situation recognition map as necessary) indicating a result of the recognition process to the self-position estimation unit 132, the situation prediction unit 154, and the like. Further, the situation recognition unit 153 stores the situation recognition map in the storage unit 111.

The situation prediction unit 154 performs a prediction process of a situation related to the own vehicle on the basis of data or signals from each unit of the vehicle control system 100 such as the map analysis unit 151, the traffic rule recognition unit 152, and the situation recognition unit 153. For example, the situation prediction unit 154 performs a prediction process of a situation of the own vehicle, a situation around the own vehicle, a situation of the driver, and the like. 28

The situation of the own vehicle to be predicted includes, for example, behavior of the own vehicle, occurrence of abnormality, travelable distance, and the like. The situation around the own vehicle to be predicted includes, for example, behavior of moving object around the own vehicle, change in traffic signal state, change in environment such as weather, and the like. The situation of the driver to be predicted includes, for example, behavior, physical condition, and the like of the driver.

The situation prediction unit 154 supplies data indicating a result of the prediction process, together with data from the traffic rule recognition unit 152 and the situation recognition unit 153, to the route planning unit 161, the action planning unit 162, and the operation planning unit 163 of the planning unit 134, and the like.

The route planning unit 161 plans a route to a destination on the basis of data or signals from each unit of the vehicle control system 100 such as the map analysis unit 151 and the situation prediction unit 154. For example, the route planning unit 161 sets a route from the current position to a designated destination on the basis of the global map. Further, for example, the route planning unit 161 changes the route as appropriate on the basis of a situation such as a traffic jam, an accident, a traffic restriction, and a construction, a physical condition of the driver, and the like. The route planning unit 161 supplies data indicating the planned route to the action planning unit 162 and the like.

On the basis of data or signals from each unit of the vehicle control system 100 such as the map analysis unit 151 and the situation prediction unit 154, the action planning unit 162 plans actions of the own vehicle for safely traveling the route planned by the route planning unit 161 within a planned time.

For example, the action planning unit 162 performs plans of start, stop, traveling direction (for example, forward, backward, left turn, right turn, direction change, and the like), travel lane, travel speed, overtaking, or the like. The action planning unit 162 supplies data indicating planned actions of the own vehicle to the operation planning unit 163 and the like.

The operation planning unit 163 plans operations of the own vehicle for implementing the actions planned by the action planning unit 162 on the basis of data or signals from each unit of the vehicle control system 100 such as the map analysis unit 151 and the situation prediction unit 154. For example, the operation planning unit 163 performs planning of acceleration, deceleration, traveling track, and the like. The operation planning unit 163 supplies data indicating planned operations of the own vehicle to the acceleration-deceleration control unit 172 and the direction control unit 173 of the operation control unit 135, and the like.

The operation control unit 135 controls operations of the own vehicle. The operation control unit 135 includes an emergency avoidance unit 171, an acceleration-deceleration control unit 172, and a direction control unit 173.

The emergency avoidance unit 171 detects an emergency situation such as a collision, a contact, an entry into a danger zone, a driver abnormality, or a vehicle abnormality, on the basis of detection results of the outside-vehicle information detection unit 141, the inside-vehicle information detection unit 142, and the vehicle state detection unit 143. When the emergency avoidance unit 171 detects occurrence of an emergency, the emergency avoidance unit 171 plans an operation of the own vehicle to avoid the emergency such as a sudden stop or a sudden turn. The emergency avoidance unit 171 supplies data indicating the planned operation of the own vehicle to the acceleration-deceleration control unit 172, the direction control unit 173, and the like.

The acceleration-deceleration control unit 172 performs acceleration-deceleration control for implementing the operation of the own vehicle planned by the operation planning unit 163 or the emergency avoidance unit 171. For example, the acceleration-deceleration control unit 172 calculates a control target value of the driving force generator or a braking device for implementing a planned acceleration, deceleration, or sudden stop, and supplies a control command indicating the calculated control target value to the drive system control unit 107.

The direction control unit 173 performs direction control for implementing the operation of the own vehicle planned by the operation planning unit 163 or the emergency avoidance unit 171. For example, the direction control unit 173 calculates a control target value of the steering mechanism for implementing a traveling track or a sudden turn planned by the operation planning unit 163 or the emergency avoidance unit 171 and supplies a control command indicating the calculated control command value to the drive system control unit 107.

[6. Configuration Example of Information Processing Apparatus]

FIG. 12 illustrates a configuration of the vehicle control system 100 that can be mounted in the moving apparatus that executes the above-described processing, in which the processes according to the above-described embodiment can input, for example, detection information of the various sensors such as the distance sensor and the cameras to an information processing apparatus such as a PC and perform data processing, so as to calculate a distance, a size, and a position of the object.

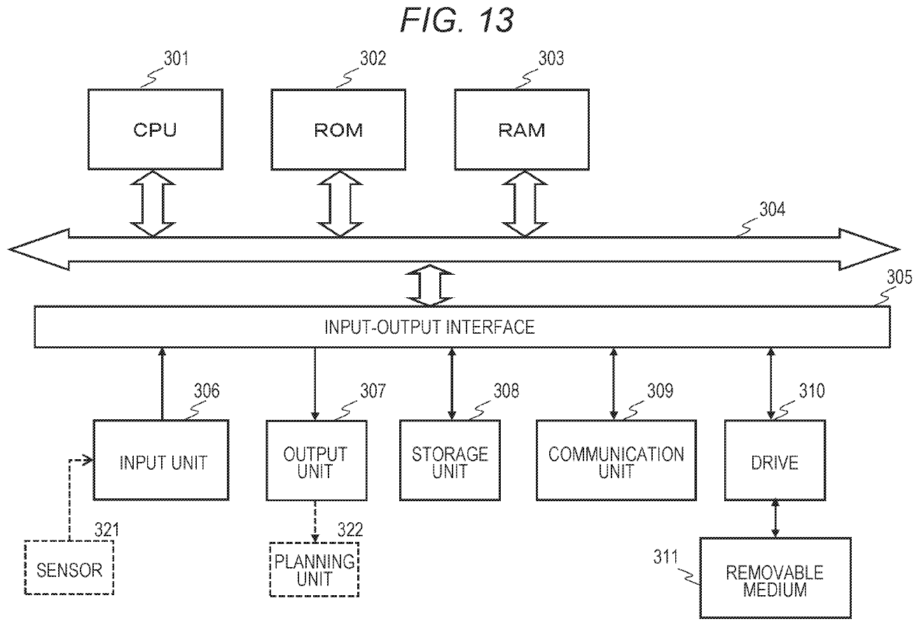

A specific hardware configuration example of the information processing apparatus in this case will be described with reference to FIG. 13.

FIG. 13 is a diagram illustrating a hardware configuration example of an information processing apparatus such as a general PC.

A central processing unit (CPU) 301 functions as a data processing unit that executes various processes according to a program stored in a read only memory (ROM) 302 or a storage unit 308. For example, processes according to the sequence described in the above-described embodiment are executed. A random access memory (RAM) 303 stores programs, data, and the like to be executed by the CPU 301. The CPU 301, the ROM 302, and the RAM 303 are connected to each other by a bus 304.

The CPU 301 is connected to an input-output interface 305 via the bus 304, and to the input-output interface 305, an input unit 306 that includes various switches, a keyboard, a touch panel, a mouse, a microphone, a status data obtaining unit such as a sensor, a camera, a GPS, and the like, and an output unit 307 that includes a display, a speaker, and the like are connected.

Note that input information from a sensor 321 such as a distance sensor or a camera is also input to the input unit 306.

Further, the output unit 307 also outputs an object distance, position information, and the like as information for the planning unit 322 such as the action planning unit of the moving apparatus.

The CPU 301 inputs a command, status data, and the like input from the input unit 306, executes various processes, and outputs a processing result to the output unit 307, for example.

The storage unit 308 connected to the input-output interface 305 includes, for example, a hard disk, and the like and stores programs executed by the CPU 301 and various data. A communication unit 309 functions as a data communication transmitting-receiving unit via a network such as the Internet or a local area network, and communicates with an external device.

A drive 130 connected to the input-output interface 305 drives a removable medium 311 such as a magnetic disk, an optical disk, a magneto-optical disk, or a semiconductor memory such as a memory card, and executes recording or reading of data.

[7. Summary of Configuration of the Present Disclosure]

As described above, the embodiment of the present disclosure has been described in detail with reference to the specific embodiment. However, it is obvious that those skilled in the art can make modifications and substitutions of the embodiment without departing from the gist of the present disclosure. In other words, the present invention has been disclosed in the form of exemplification, and should not be interpreted in a limited manner. In order to determine the gist of the present disclosure, the claims should be taken into consideration.

Note that the technology disclosed in the present description can take the following configurations.

(1) An information processing apparatus including:

an object detection unit that detects an object on the basis of an imaged image taken by a camera; and

an object distance calculation unit that calculates a distance to the object, in which

the object distance calculation unit calculates a distance to an object on the basis of actual size information of the object and an imaged image of the object.

(2) The information processing apparatus according to (1), in which

the object distance calculation unit

calculates the distance to the object by applying a ratio between a size of a captured image of the object and an actual size of the object.

(3) The information processing apparatus according to (1) or (2), further including

an object position calculation unit that calculates a position of the object by applying distance information to the object calculated by the object distance calculation unit and a captured image of the object.

(4) The information processing apparatus according to (3), in which

the distance information to the object calculated by the object distance calculation unit is a distance to an object in a camera optical axis direction, and

the object position calculation unit

calculates an angle formed by a line connecting a camera origin and an end point of the object and a camera optical axis by applying the distance to the object in the camera optical axis direction and information of the image, and calculates a position of the end point of the object on the basis of the calculated angle.

(5) The information processing apparatus according to any one of (1) to (4), in which

the camera

is a camera that images leftward, rightward, or backward of a moving apparatus, and

the actual size information of the object

is actual size information calculated by applying an image imaged by a forward camera that images forward of the moving apparatus and distance information measured by a distance sensor that measures a distance to an object ahead of the moving apparatus.

(6) The information processing apparatus according to any one of (1) to (5), in which

the camera is a camera that images an image outside a distance measurable area by a distance sensor, and

the actual size information of the object

is actual size information calculated by an object actual size calculation unit by applying a preceding imaged image imaged by a preceding imaging camera that images an image in the distance measurable area by the distance sensor and distance information measured by the distance sensor.

(7) The information processing apparatus according to (6), in which

the object actual size calculation unit

calculates two end point positions of the object using the distance information measured by the distance sensor and the preceding imaged image, and calculates a difference between the two end point positions as a width of the object.

(8) The information processing apparatus according to any one of (1) to (7), further having

an object tracking unit that gives an identifier (ID) to an object imaged by the camera, in which

the object tracking unit

determines whether or not an identifier setting target object is same as an object that is already imaged by another camera, and if the identifier setting target object is the same, an identifier that is already set to the object is obtained from a storage unit and set.

(9) The information processing apparatus according to any one of (1) to (8), in which

if the actual size information of the object is not obtainable,

the object distance calculation unit determines a type of the object on the basis of feature information of the object, obtains typical size information corresponding to an object type stored in advance in a storage unit, and

calculates the distance to the object by applying the typical size information obtained and the image information.

(10) A moving apparatus including:

a forward camera that images a forward image of the moving apparatus;

a distance sensor that measures a distance to an object in a forward direction of the moving apparatus;

a second direction camera that images a second direction image other than the forward direction of the moving apparatus;

an object distance calculation unit that inputs a second direction image imaged by the second direction camera and calculates a distance to an object in the second direction image;

a planning unit that determines a path of the moving apparatus on the basis of distance information to the object calculated by the object distance calculation unit; and

an operation control unit that performs operation control of the moving apparatus according to the path determined by the planning unit, in which

the object distance calculation unit

calculates a distance to the object on the basis of actual size information of the object and a captured image of the object included in the second direction image.

(11) The moving apparatus according to (10), in which

the object distance calculation unit

calculates a distance to the object by applying a ratio between an image size of an image object in the second direction image and an actual size of a real object in real space.

(12) The moving apparatus according to (10) or (11), further having

an object position calculation unit that calculates a position of an object by applying calculation information of the object distance calculation unit and the image information.

(13) The moving apparatus according to any one of (10) to (12), in which

the actual size information of the object

is actual size information calculated by applying a forward image imaged by the forward camera and distance information measured by the distance sensor.

(14) The moving apparatus according to any one of (10) to (13), further has

an object tracking unit that gives an identifier (ID) to an object imaged by the camera, in which

the object tracking unit

determines whether or not an identifier setting target object is same as an imaged object by a preceding imaging camera, and if the identifier setting target object is the same, an identifier that is already set to the object is obtained from a storage unit and set.

(15) The moving apparatus according to any one of (10) to (14), in which

if the actual size information of the object is not obtainable,

the object distance calculation unit determines a type of the object on the basis of feature information of the object, obtains typical size information corresponding to an object type stored in advance in a storage unit, and

calculates the distance to the object by applying the typical size information obtained and the image information.

(16) An information processing method executed in an information processing apparatus, the method having

an object distance calculation step in which an object distance calculation unit inputs an imaged image taken by a camera, and calculates a distance of an object in the image, in which

the object distance calculation step

calculates a distance to the object by applying actual size information of the object and image information of an image object included in the imaged image.

(17) A moving apparatus control method executed in a moving apparatus, in which

the moving apparatus includes:

a forward camera that images a forward image of the moving apparatus;

a distance sensor that measures a distance to an object in a forward direction of the moving apparatus; and

a second direction camera that images a second direction image other than the forward direction of the moving apparatus,

the moving apparatus control method includes:

an object distance calculation step in which an object distance calculation unit inputs an imaged image taken by the camera and calculates a distance of an object in the image;

a planning step in which a planning unit inputs object distance information calculated by the object distance calculation unit and determines a path of the moving apparatus; and

an operation control step in which an operation control unit performs operation control of the moving apparatus according to the path determined by the planning unit, and

the object distance calculating step

is a step of calculating a distance to the object by applying actual size information of the object and image information of an image object included in the second direction image.

(18) A program that executes information processing in an information processing apparatus, having

an object distance calculation step in which an object distance calculation unit inputs an imaged image taken by a camera and calculates a distance of an object in the image, in which

the program causes the object distance calculating step to

calculate a distance to the object by applying actual size information of the object and image information of an image object included in the imaged image.

(19) A program that executes a moving apparatus control process in a moving apparatus, in which

the moving apparatus includes:

a forward camera that images a forward image of the moving apparatus;

a distance sensor that measures a distance to an object in a forward direction of the moving apparatus; and

a second direction camera that images a second direction image other than the forward direction of the moving apparatus,

the program executes:

an object distance calculation step in which an object distance calculation unit inputs an imaged image taken by the camera and calculates a distance of an object in the image;

a planning step in which a planning unit inputs object distance information calculated by the object distance calculation unit and determines a path of the moving apparatus; and

an operation control step in which an operation control unit performs operation control of the moving apparatus according to the path determined by the planning unit, and

in the object distance calculating step,

a distance to the object is calculated by applying actual size information of the object and image information of an image object included in the second direction image.

Further, a series of processes described in the present description can be executed by hardware, software, or a combined configuration of the both. In a case of executing processes by software, a program recording a processing sequence is installed and run on a memory in a computer incorporated in dedicated hardware, or the program can be installed and run on a general-purpose computer capable of executing various processes. For example, the program can be recorded in advance on a recording medium. In addition to being installed on a computer from a recording medium, the program can be received via a network such as a local area network (LAN) or the Internet and installed on a recording medium such as an internal hard disk.

Note that the various processes described in the description are not only executed in time series according to the description, but may be executed in parallel or individually according to processing capability of the apparatus that executes the processes or as necessary. Further, a system in the present description is a logical set configuration of a plurality of devices, and is not limited to one in which devices with respective configurations are in the same enclosure.

### INDUSTRIAL APPLICABILITY

As described above, according to a configuration of an embodiment of the present disclosure, a configuration for calculating a distance and a position of an object included in an image in a direction in which distance measurement by a distance sensor is impossible is achieved.

Specifically, for example, there is included an object distance calculation unit that inputs an imaged image taken by a camera and calculates a distance of an object in the image, and the object distance calculation unit calculates a distance to the object by applying actual size information of the object and image information of an image object included in the imaged image. Moreover, an object position calculation unit calculates an object position using calculation information of the object distance calculation unit and the image information. An object actual size is obtained on the basis of an imaged image in a direction in which distance measurement by the distance sensor is possible.

With this configuration, a configuration for calculating a distance and a position of an object included in an image in a direction in which distance measurement by a distance sensor is impossible is achieved.

### REFERENCE SIGNS LIST

10 Moving apparatus
11 Forward camera
12 Backward camera
13 Leftward camera
14 Rightward camera
21 Forward distance sensor
40 Distance sensor
41 Forward camera
42 Backward camera
43 Leftward camera
44 Rightward camera
50 Information processing apparatus
51 Distance sensor output information analysis unit
52 Object detection unit
53 Object tracking and analysis unit
54 Object distance calculation unit
55 Object position and actual size calculation unit
100 Vehicle control system
101 Input unit
102 Data obtaining unit
103 Communication unit
104 In-vehicle device
105 Output control unit
106 Output unit
107 Drive system control unit
108 Drive system
109 Body system control unit
110 Body system
111 Storage unit
112 Autonomous driving control unit
121 Communication network
131 Detection unit
132 Self-position estimation unit
141 Outside-vehicle information detection unit
142 Inside-vehicle information detection unit
143 Vehicle state detection unit
151 Map analysis unit
152 Traffic rule recognition unit
153 Situation recognition unit
154 Situation prediction unit
161 Route planning unit
162 Action planning unit
163 Operation planning unit
171 Emergency avoidance unit
172 Acceleration-deceleration control unit
173 Direction control unit
301 CPU
302 ROM
303 RAM
304 Bus
305 I/O interface
306 Input unit
307 Output unit
308 Storage unit
309 Communication unit
310 Drive
311 Removable medium
321 Sensor
322 Planning unit

1. An information processing apparatus comprising:
an object detection unit that detects an object on a basis of an imaged image taken by a camera; and
an object distance calculation unit that calculates a distance to the object, wherein
the object distance calculation unit calculates a distance to an object on a basis of actual size information of the object and an imaged image of the object.

2. The information processing apparatus according to claim 1, wherein
the object distance calculation unit
calculates the distance to the object by applying a ratio between a size of a captured image of the object and an actual size of the object.

3. The information processing apparatus according to claim 1, further comprising
an object position calculation unit that calculates a position of the object by applying distance information to the object calculated by the object distance calculation unit and a captured image of the object.

4. The information processing apparatus according to claim 3, wherein
the distance information to the object calculated by the object distance calculation unit is a distance to an object in a camera optical axis direction, and
the object position calculation unit
calculates an angle formed by a line connecting a camera origin and an end point of the object and a camera optical axis by applying the distance to the object in the camera optical axis direction and information of the image, and calculates a position of the end point of the object on a basis of the calculated angle.

5. The information processing apparatus according to claim 1, wherein
the camera
is a camera that images leftward, rightward, or backward of a moving apparatus, and
the actual size information of the object
is actual size information calculated by applying an image imaged by a forward camera that images forward of the moving apparatus and distance information measured by a distance sensor that measures a distance to an object ahead of the moving apparatus.

6. The information processing apparatus according to claim 1, wherein
the camera is a camera that images an image outside a distance measurable area by a distance sensor, and
the actual size information of the object
is actual size information calculated by an object actual size calculation unit by applying a preceding imaged image imaged by a preceding imaging camera that images an image in the distance measurable area by the distance sensor and distance information measured by the distance sensor.

7. The information processing apparatus according to claim 6, wherein
the object actual size calculation unit
calculates two end point positions of the object using the distance information measured by the distance sensor and the preceding imaged image, and calculates a difference between the two end point positions as a width of the object.

8. The information processing apparatus according to claim 1, further comprising
an object tracking unit that gives an identifier (ID) to an object imaged by the camera, wherein
the object tracking unit
determines whether or not an identifier setting target object is same as an object that is already imaged by another camera, and if the identifier setting target object is the same, an identifier that is already set to the object is obtained from a storage unit and set.

9. The information processing apparatus according to claim 1, wherein
if the actual size information of the object is not obtainable,
the object distance calculation unit determines a type of the object on a basis of feature information of the object, obtains typical size information corresponding to an object type stored in advance in a storage unit, and
calculates the distance to the object by applying the typical size information obtained and the image information.

10. A moving apparatus comprising:
a forward camera that images a forward image of the moving apparatus;
a distance sensor that measures a distance to an object in a forward direction of the moving apparatus;
a second direction camera that images a second direction image other than the forward direction of the moving apparatus;
an object distance calculation unit that inputs a second direction image imaged by the second direction camera and calculates a distance to an object in the second direction image;
a planning unit that determines a path of the moving apparatus on a basis of distance information to the object calculated by the object distance calculation unit; and
an operation control unit that performs operation control of the moving apparatus according to the path determined by the planning unit, wherein
the object distance calculation unit
calculates a distance to the object on a basis of actual size information of the object and a captured image of the object included in the second direction image.

11. The moving apparatus according to claim 10, wherein
the object distance calculation unit
calculates a distance to the object by applying a ratio between an image size of an image object in the second direction image and an actual size of a real object in real space.

12. The moving apparatus according to claim 10, further comprising
an object position calculation unit that calculates a position of an object by applying calculation information of the object distance calculation unit and the image information.

13. The moving apparatus according to claim 10, wherein
the actual size information of the object
is actual size information calculated by applying a forward image imaged by the forward camera and distance information measured by the distance sensor.

14. The moving apparatus according to claim 10, further comprising
an object tracking unit that gives an identifier (ID) to an object imaged by the camera, wherein
the object tracking unit
determines whether or not an identifier setting target object is same as an imaged object by a preceding imaging camera, and if the identifier setting target object is the same, an identifier that is already set to the object is obtained from a storage unit and set.

15. The moving apparatus according to claim 10, wherein
if the actual size information of the object is not obtainable,
the object distance calculation unit determines a type of the object on a basis of feature information of the object, obtains typical size information corresponding to an object type stored in advance in a storage unit, and
calculates the distance to the object by applying the typical size information obtained and the image information.

16. An information processing method executed in an information processing apparatus, the method comprising
an object distance calculation step in which an object distance calculation unit inputs an imaged image taken by a camera, and calculates a distance of an object in the image, wherein
the object distance calculation step
calculates a distance to the object by applying actual size information of the object and image information of an image object included in the imaged image.

17. A moving apparatus control method executed in a moving apparatus, wherein
the moving apparatus includes:
a forward camera that images a forward image of the moving apparatus;
a distance sensor that measures a distance to an object in a forward direction of the moving apparatus; and
a second direction camera that images a second direction image other than the forward direction of the moving apparatus,
the moving apparatus control method comprises:
an object distance calculation step in which an object distance calculation unit inputs an imaged image taken by the camera and calculates a distance of an object in the image;
a planning step in which a planning unit inputs object distance information calculated by the object distance calculation unit and determines a path of the moving apparatus; and
an operation control step in which an operation control unit performs operation control of the moving apparatus according to the path determined by the planning unit, and
the object distance calculating step
is a step of calculating a distance to the object by applying actual size information of the object and image information of an image object included in the second direction image.

18. A program that executes information processing in an information processing apparatus, comprising
an object distance calculation step in which an object distance calculation unit inputs an imaged image taken by a camera and calculates a distance of an object in the image, wherein
the program causes the object distance calculating step to
calculate a distance to the object by applying actual size information of the object and image information of an image object included in the imaged image.

19. A program that executes a moving apparatus control process in a moving apparatus, wherein
the moving apparatus comprises:
a forward camera that images a forward image of the moving apparatus;
a distance sensor that measures a distance to an object in a forward direction of the moving apparatus; and
a second direction camera that images a second direction image other than the forward direction of the moving apparatus,
the program executes:
an object distance calculation step in which an object distance calculation unit inputs an imaged image taken by the camera and calculates a distance of an object in the image;
a planning step in which a planning unit inputs object distance information calculated by the object distance calculation unit and determines a path of the moving apparatus; and
an operation control step in which an operation control unit performs operation control of the moving apparatus according to the path determined by the planning unit, and
in the object distance calculating step,
a distance to the object is calculated by applying actual size information of the object and image information of an image object included in the second direction image.
